(19) United States
(12) Patent Application Publication
(10) Pub. No.: US 2023/0214812 A1
(43) Pub. Date: Jul. 6, 2023

(54) ARTICLE MANAGEMENT SYSTEM AND ARTICLE MANAGEMENT METHOD

(71) Applicant: PANASONIC INTELLECTUAL PROPERTY MANAGEMENT CO., LTD., Osaka (JP)

(72) Inventor: Suguru KOJIMA, Kanagawa (JP)

(73) Assignee: PANASONIC INTELLECTUAL PROPERTY MANAGEMENT CO., LTD., Osaka (JP)

(21) Appl. No.: 18/120,118

(22) Filed: Mar. 10, 2023

Related U.S. Application Data
(62) Division of application No. 17/048,378, filed on Oct. 16, 2020.

(30) Foreign Application Priority Data
Apr. 25, 2018 (JP) 2018-083838
Feb. 21, 2019 (JP) 2019-029081

(51) Int. Cl. G06Q 10/087; G06K 7/10; G06K 19/077

(52) U.S. Cl. CPC G06Q 10/087; G06K 7/10366; G06K 19/07773

(57) ABSTRACT

An article management system includes one or more first antennas provided on a side of a first prescribed region and one or more second antennas provided on a side of a second prescribed region such that the first antennas and the second antennas have respective reading target areas which at least partially do not overlap with each other; a reader/writer configured to read article information stored in an RFID tag attached to an article by using the first antennas and the second antennas, respectively; and a management device configured to manage the article information read by the reader/writer from the RFID tag.

This is a divisional of U.S. Pat. Appl. No. 17/048,378, filed Oct. 16, 2020, which is a National Stage Entry of Int. Pat. Appl. No. PCT/JP2019/016628, filed Apr. 18, 2019, which claims priority to Jap. Pat. Appl. No. 2019-029081, filed Feb. 21, 2019, and to Jap. Pat. Appl. No. 2018-083838, filed Apr. 25, 2018. The entire disclosure of each of the aboveidentified documents, including the specification, drawings, and claims, is incorporated herein by reference in its entirety.

### TECHNICAL FIELD

The present invention relates to an article management system and an article management method for determining movement of an article with an attached RFID tag.

### BACKGROUND ART

In recent years, retail stores and other establishments have an option to use RFID (Radio Frequency Identifier) technology instead of barcodes, in order to promote efficiency in shoppers’ payments at checkout. RFID technology enables users to read multiple RFID tags attached to respective items simultaneously at a separated place, thereby improving efficiency and speed of payments at checkout. In addition, use of RFID technology enables the introduction of self-checkout systems (unmanned checkout systems) for the purpose of reducing personnel costs.

Known checkout systems using such RFID technology includes an item information registering device, which includes a wireless tag reader configured to read information stored in wireless tags (RFID tags), an optical reader configured to scan barcode type symbols representing item ID information, a registration device for storing information read by the wireless tag reader and the optical reader, where respective reading target areas of the wireless tag reader and the optical reader are located on a path of movement of items to be registered (Patent Document 1).

Moreover, in recent years, use of RFID technology for managing articles has been widely put into practical use, and a recent application of the technology is that use of RFID technology in unmanned store systems in the form of refrigerators. Such an unmanned store system includes a refrigeration storage for storing articles to which RFID tags are attached, and a reader/writer provided with antennas for reading each RFID tag in order to determine if a corresponding article is drawn out of the refrigeration storage. In addition, the system includes a checkout terminal provided on a door of the refrigeration storage or any other suitable location, which allows users to make payments themselves for articles which have been determined to be drawn out of the refrigeration storage.

Known systems in which RFID technology is used to determine that an article has been removed from and/or placed in an article storage, include a storage cabinet apparatus comprising: at least one storage cabinet compartment having an opening for access to the cabinet compartment; a first sensor positioned within the storage cabinet to have a first zone of sensing; and a second sensor positioned within the storage cabinet to have a second zone of sensing; wherein, compared to the second zone of sensing, the first zone of sensing is closer to the opening of the storage cabinet compartment; and wherein the first sensor and the second sensor are configured to sense an inventory item in the first zone of sensing and the second zone of sensing respectively (Patent Document 2).

### PRIOR ART DOCUMENT (S)

### Patent Document(s)

Patent Document 1: JP3839817B
Patent Document 2: JP2012-533118A

### SUMMARY OF THE INVENTION

### Task to Be Accomplished by the Invention

In the above-described prior art technology disclosed in Patent Document 1, an item information registration device is configured such that, when an item is moved from a basket for items to be registered, to another basket for registered items, a wireless tag reader, which is located on a path of the movement of the item, reads information stored in a wireless tag (an RFID tag) attached to the item.

However, the above-described prior art technology of Patent Document 1 has a problem that an area outside a reading target area of the wireless tag reader is also irradiated with radio waves radiated from the wireless tag reader, and the wireless tag reader undesirably reads a wireless tag attached to an item which is not desired to be read and positioned in the area outside to the reading target area. For example, since nearby areas outside a reading target area can also be irradiated with radio waves radiated directly from the wireless tag reader or with reflected radio waves reflected from the ceiling, the floor, a wall, or a cash register body, the wireless tag reader can unnecessarily read RFID tags attached to items positioned in those outside areas, e.g., items in shopping carts of shoppers lined up at the next checkout or those lined up behind the paying shopper, or items displayed in a showcase. This problem becomes significantly worse when the radio wave output of a wireless tag reader is powered up in order to increase the reading rate of the wireless tag reader. Therefore, the above-described prior art technology of Patent Document 1 has a problem of being unable to reliably determine a movement of an item (an article) to which an RFID tag is attached.

In the above-described prior art technology disclosed in Patent Document 2, the storage cabinet apparatus determines that an article has been removed from or placed in an article storage (storage cabinet compartment) by detecting that the article passes through the first zone of sensing and the second zone of sensing in order. This produces a problem that the first and second zones of sensing become a dead space which cannot be used for storage of articles. Thus, the prior art technology of Patent Document 2 is not suitable for being applied to unmanned store systems in the form of refrigerators, which are desirably capable of displaying many articles in the article storage.

In order to cope with this problem, some recent unmanned store systems in the form of refrigerators are configured to simultaneously read RFID tags attached to respective articles displayed in the article storage by using antennas of a reader/writer appropriately positioned in the article storage, and adopt a determination method in which, upon detecting that a certain RFIC tag cannot be read, a system determines that a correspond article has been removed from the article storage.

However, in the determination method, since a system is required to reliably read RFID tags of respective articles displayed in the article storage by using the antennas, articles (in particular, products including water or metal) need to be displayed separately from each other by a predetermined separation distance. Moreover, since the presence of metal behind an RFID tag can block communications between the RFID tag and antennas and shorten the communication distance therebetween, articles need to be displayed separated from metal parts of the article storage (such as metal inner surfaces of the article storage) by at least a certain distance. Therefore, the above-described prior art technology of Patent Document 2 has a problem that, in cases where distances between items in the article storage and/or positions of items in the article storage is/are not appropriate, the system cannot reliably determine a removal (movement) of an item (an article) to which an RFID tag is attached.

The present invention has been made in view of such problems of the prior art, and a primary object of the present invention is to provide an article management system and an article management method which enable reliable determination of a movement of an article to which an RFID tag is attached.

### Means to Accomplish the Task

An aspect of the present invention provides an article management system for determining movement of an article to which an RFID tag is attached, comprising: one or more first antennas provided on a side of a first prescribed region and one or more second antennas provided on a side of a second prescribed region such that the first antennas and the second antennas have respective reading target areas which at least partially do not overlap with each other; a reader/writer configured to read article information stored in the RFID tag attached to the article by using the first antennas and the second antennas, respectively; and a management device configured to manage the article information read by the reader/writer from the RFID tag, wherein, for each RFID tag from which the reader/writer has read article information stored therein, the management device determines that a corresponding article to which the RFID tag is attached has been moved between the first prescribed region and the second prescribed region based on a change in a reading status with regard to respective readings of the RFID tag taken by using the first antennas and the second antennas.

Another aspect of the present invention provides an article management method for determining movement of an article to which an RFID tag is attached, the article management method using a reader/writer which includes one or more first antennas provided on a side of a first prescribed region and one or more second antennas provided on a side of a second prescribed region such that the first antennas and the second antennas have respective reading target areas which at least partially do not overlap with each other, the method comprising: a first reading step in which the reader/writer reads article information stored in the RFID tag attached to the article by using the first antennas; a second reading step in which the reader/writer reads the article information stored in the RFID tag attached to the article by using the second antennas; and a determination step of determining, for each RFID tag from which the reader/writer has read article information stored therein, that a corresponding article to which the RFID tag is attached has been moved between the first prescribed region and the second prescribed region based on a change in a reading status with regard to respective readings of the RFID tag taken by using the first antennas and the second antennas.

### Effect of the Invention

An article management system and an article management method according to the present invention enable reliable determination of a movement of an article to which an RFID tag is attached.

### BRIEF DESCRIPTION OF THE DRAWINGS

FIG. 1 is a diagram showing a general configuration of an article management system (checkout system) according to a first embodiment of the present invention;

FIG. 2 is a perspective view showing a checkout counter on which the first and second antennas are provided;

FIG. 3 is a diagram showing how a payment is made at checkout according to the first embodiment;

FIG. 4 is a block diagram showing a schematic configuration of the management device;

FIG. 5 is a flow chart illustrating a processing operation for determining purchase of an article (an item) performed by the management device;

FIG. 6 is a flow chart illustrating a first variation of the processing operation in FIG. 5;

FIG. 7 is a flow chart illustrating a second variation of the processing operation in FIG. 5;

FIG. 8 is a flow chart illustrating a third variation of the processing operation in FIG. 5;

FIG. 9 is a flow chart illustrating a fourth variation of the processing operation in FIG. 5;

FIG. 10 is a diagram showing a system according to a second embodiment, in a similar situation to that of the first embodiment shown in FIG. 3;

FIG. 11 is a diagram showing a system according to a third embodiment, in a similar situation to that of the first embodiment shown in FIG. 3;

FIG. 12 is a diagram showing a system according to a fourth embodiment, in a similar situation to that of the first embodiment shown in FIG. 3;

FIG. 13 is a diagram showing a checkout counter on which pluralities of first and second antennas are provided, in the system of the first embodiment;

FIG. 14 is a diagram showing a checkout counter on which pluralities of first and second antennas are provided, in the system of the fourth embodiment;

FIG. 15 is a diagram showing a general configuration of an article management system according to a fifth embodiment of the present invention;

FIG. 16A and FIG. 16B illustrate an article storage of an article management system, in which FIG. 16A is a perspective view of the article storage with its door open, and FIG. 16B is a perspective view of the article storage with its door closed;

FIG. 17A and FIG. 17B illustrate how the door is moved when an article is removed from the article storage, in which FIG. 17A is a top view of the article storage with its door open, and FIG. 17B is a top view of the article storage with its door closed;

FIG. 18 is a flow chart illustrating a processing operation for determining removal of an article from an article storage according to the fifth embodiment;

FIG. 19 is a flow chart illustrating a variation of the processing operation in FIG. 18;

FIG. 20A and FIG. 20B illustrate an article storage of an article management system according to a sixth embodiment, which corresponds to that of the fifth embodiment shown in FIG. 16;

FIG. 21A and FIG. 21B illustrate an article storage of an article management system according to a seventh embodiment, which corresponds to that of the fifth embodiment shown in FIG. 16;

FIG. 22 is a diagram showing a general configuration of an article management system according to an eighth embodiment of the present invention; and

FIG. 23 is a flow chart illustrating a processing operation for determining removal or placement of an item from and in an article storage according to the eighth embodiment.

### DESCRIPTION OF THE PREFERRED EMBODIMENT(S)

A first aspect of the present invention made to achieve the above-described object is an article management system for determining movement of an article to which an RFID tag is attached, comprising: one or more first antennas provided on a side of a first prescribed region and one or more second antennas provided on a side of a second prescribed region such that the first antennas and the second antennas have respective reading target areas which at least partially do not overlap with each other; a reader/writer configured to read article information stored in the RFID tag attached to the article by using the first antennas and the second antennas, respectively; and a management device configured to manage the article information read by the reader/writer from the RFID tag, wherein, for each RFID tag from which the reader/writer has read article information stored therein, the management device determines that a corresponding article to which the RFID tag is attached has been moved between the first prescribed region and the second prescribed region based on a change in a reading status with regard to respective readings of the RFID tag taken by using the first antennas and the second antennas.

This configuration can determine, for each RFID tag from which the reader/writer has read article information stored therein, that a corresponding article to which the RFID tag is attached has been moved between the first prescribed region and the second prescribed region based on a change in a reading status with regard to respective readings of the RFID tag taken by using the first antennas and the second antennas. As a result, the system is enabled to reliably determine a movement of an article to which an RFID tag is attached.

A second aspect of the present invention is the article management system of the first aspect, wherein the management device measures reception signal intensities of first and second signals received from each RFID tag by using the first antennas and the second antennas, respectively, and determines that the article to which the RFID tag is attached has been moved from the first prescribed region to the second prescribed region when the reading status changes from a status in which the reception signal intensity of the first signal is higher than that of the second signal to a status in which the reception signal intensity of the first signal is lower than that of the second signal.

This configuration can determine a change in the reading status with regard to respective readings of an RFID tag taken by using the first and second antennas, based on reception signal intensities of first and second signals received from each RFID tag by using the first antennas and the second antennas, respectively. Thus, the system can determine that the article to which the RFID tag is attached has been moved from the first prescribed region to the second prescribed region based on the reception signal intensities of the first and second signals received from each RFID tag by using the first antennas and the second antennas, respectively.

A third aspect of the present invention is the article management system of the first aspect, wherein a shielding plate is provided between the first antennas and the second antennas for shielding radio waves emitted from the first and second antennas.

This configuration can decrease leakage of radio waves emitted from the first and second antennas from the first and second prescribed regions, respectively, thereby reducing the rate of incorrect readings of RFID tags.

A fourth aspect of the present invention is the article management system of the first aspect, wherein the article is an article purchased by a shopper, wherein the first prescribed region is a region in which articles before payment at checkout are placed, wherein the second prescribed region is a region in which articles after payment at checkout are placed, and wherein, for each tag read by the reader/writer, the management device determines that the article to which the RFID tag is attached has been purchased based on the change in the reading status with regard to respective readings of the RFID tag taken by using the first antennas and the second antennas.

This configuration can determine, for each RFID tag read by the reader/writer, that the article to which the tag is attached has been purchased based on the change in the reading status with regard to respective readings of the tag by using the first and second antennas. This enables reduction of the rate of incorrect readings of RFID tags when RFID technology is used in payments for articles.

A fifth aspect of the present invention is the article management system of the fourth aspect, wherein the management device measures reception signal intensities of first and second signals received from each RFID tag by using the first antennas and the second antennas, respectively, and wherein the management device determines that the article to which the RFID tag is attached has been purchased when the reading status changes from a status in which the reception signal intensity of the first signal is higher than that of the second signal to a status in which the reception signal intensity of the first signal is lower than that of the second signal.

This configuration can determine a change in the reading status with regard to respective readings of an RFID tag taken by using the first and second antennas, based on reception signal intensities of first and second signals received from each RFID tag by using the first antennas and the second antennas, respectively. Thus, the system can readily determine that the article to which the RFID tag is attached has been purchased based on the reception signal intensities of the first and second signals received from each RFID tag by using the first antennas and the second antennas, respectively.

A sixth aspect of the present invention is the article management system of the fourth aspect, , wherein the reader/writer further comprises one or more third antennas between the first and second antennas such that the third antennas’ reading target area at least partially does not overlap with those of the first and second antennas, and that the reader/writer further reads article information stored in the RFID tag attached to the article by using the third antennas, wherein, for each RFID tag from which the reader/writer has read article information stored therein, the management device determines that the article to which the RFID tag is attached has been purchased based on the change in the reading status with regard to a reading of the RFID tag taken by using the third antennas, in addition to the change in the reading status with regard to respective readings of the RFID tag taken by using the first antennas and the second antennas.

This configuration can determine, for each RFID tag read by the reader/writer, that the article to which the tag is attached has been purchased based on the change in the reading status with regard to a reading of the RFID tag taken by using the third antenna, in addition to the reading status with regard to respective readings of the RFID tag taken by using the first and second antennas. This enables further reduction of the rate of incorrect readings of RFID tags.

A seventh aspect of the present invention is the article management system of the sixth aspect, wherein the management device measures reception signal intensities of first, second, and third signals received from each RFID tag by using the first, second, and third antennas, respectively, and determines that the article to which the RFID tag is attached has been purchased when the reading status changes from a status in which the reception signal intensity of the first signal is higher than that of the third signal, to a status in which the reception signal intensity of the first signal is lower than that of the third signal, and subsequently, the reading status further changes from a status in which the reception signal intensity of the third signal is higher than that of the second signal to a status in which the reception signal intensity of the third signal is lower than that of the second signal.

This configuration can determine a change in the reading status with regard to respective readings of an RFID tag taken by using the first, second, and third antennas, based on reception signal intensities of first, second, and third signals received from each RFID tag by using the first antennas and the second antennas, respectively. Thus, the system can readily determine that the article to which the RFID tag is attached has been purchased based on the reception signal intensities of the first, second, and third signals received from each RFID tag by using the first, second, and third antennas, respectively.

An eighth aspect of the present invention is the article management system of the sixth aspect, wherein shielding plates is provided between any two of the first, second, and third antennas for shielding radio waves emitted from the respective first, second, and third antennas.

This configuration can decrease leakage of radio waves between the first, second, and third antennas, thereby further reducing the rate of incorrect readings of RFID tags.

A ninth aspect of the present invention is the article management system of the fourth aspect, wherein the article management system comprises a sensor capable of detecting that articles before payment at checkout are placed in the first prescribed region, and detecting that the articles before payment at checkout are removed from the first prescribed region, wherein the management device is configured to: activate the reader/writer when the sensor detects that articles before payment at checkout are placed in the first prescribed region; and end the reader/writer’s operation when the sensor detects that articles before payment at checkout are removed from the first prescribed region.

In this configuration, the reader/writer does not read other than at times payments are made, thereby enabling further reduction of the rate of incorrect readings of RFID tags.

A tenth aspect of the present invention is the article management system of the first aspect, wherein the article is an article to be stored in an article storage, wherein the first prescribed region is a region within the article storage, wherein the second prescribed region is a region outside the article storage, and wherein, for each tag read by the reader/writer, the management device determines that the article to which the RFID tag is attached has been removed from and/or placed in the article storage based on the change in the reading status with regard to the reader/writer’s readings of the first and second signals.

This configuration can determine, for each RFID tag from which the reader/writer has read article information stored therein, that the article to which the tag is attached has been removed from and/or placed in the article storage based on a change in a reading status with regard to respective readings of the RFID tag taken by using the first antennas and the second antennas. As a result, the system is enabled to reliably determine that the article has been placed in and/or removed from the article storage with the use of RFID technology, without being restricted by how articles are placed in the article storage.

An eleventh aspect of the present invention is the article management system of the tenth aspect, wherein the management device measures reception signal intensities of first and second signals received from each RFID tag by using the first antennas and the second antennas, respectively, and wherein the management device determines that the article to which the RFID tag is attached has been removed from the article storage when the reading status changes from a status in which the reception signal intensity of the first signal is higher than that of the second signal, to a status in which the reception signal intensity of the first signal is lower than that of the second signal, and determines that the article to which the RFID tag is attached has been placed in the article storage when the reading status changes from a status in which the reception signal intensity of the second signal is higher than that of the first signal, to a status in which the reception signal intensity of the second signal is lower than that of the first signal.

This configuration can determine a change in the reading status with regard to respective readings of an RFID tag taken by using the first and second antennas, based on reception signal intensities of first and second signals received from each RFID tag by using the first antennas and the second antennas, respectively. Thus, the system can readily determine that the article to which the RFID tag is attached has been removed from or placed in the article storage based on the reception signal intensities of the first and second signals received from each RFID tag by using the first antennas and the second antennas, respectively.

A twelfth aspect of the present invention is the article management system of the tenth aspect, wherein the article storage includes a hinged door to be used when the article is removed from or placed in the article storage, wherein the first antennas are provided on an inner surface of the door, and wherein the second antennas are provided on an outer surface of the door.

This configuration can reliably read an RFID tag attached to an article, which is passing near the door when the article is removed from or placed in the article storage, by using the first and second antennas which are provided on the inner surface and the outer surface of the door, respectively. Thus, the system can make more accurate determination based on a change in a reading status with regard to respective readings of the RFID tag taken by using the first antennas and the second antennas.

A thirteenth aspect of the present invention is the article management system of the twelfth aspect, wherein the article storage further comprises a drawer configured to be housed in the article storage when the door is closed and to be pulled out along with the door to which the drawer is connected when the door is opened, and wherein at least one of the first antennas is provided on the drawer.

This configuration can read, when removal or placement of an article from and in the article storage, an RFID tag attached to the article from different angles with two or more of the first antennas. Thus, the configuration can minimize the formation of null points due to multipath, antennas’ orientations or other reasons, thereby improving the accuracy of readings of RFID tags. The null point refers to a location where an reader/writer cannot read RFID tags even though the reader/writer’s antennas are ready for wireless communications with the RFID tags there, for example, due to mutual cancellation of radio waves radiated from the reader/writer and their reflected radio waves, where the reflected radio waves are formed by reflections from other objects, walls, the floor, the ceiling, and other things around the reader/writer.

A fourteenth aspect of the present invention is the article management system of the twelfth aspect, wherein at least parts of the door where the first and second antennas are disposed are formed of an electromagnetic shielding material or a radio wave absorbing material.

This configuration can secure the isolation between the first and second antennas, thereby improving the accuracy of readings of RFID tags.

A fifteenth aspect of the present invention is the article management system of the twelfth aspect, wherein at least parts of the door where the first and second antennas are disposed are made transparent, and wherein the first and second antennas are formed of transparent electrically conductive material.

This configuration enables users to visually recognize articles stored in the article storage from the outside through the parts of the door where the first and second antennas are disposed.

A sixteenth aspect of the present invention is the article management system of the tenth aspect, wherein the reader/writer further comprises one or more third antennas between the first and second antennas such that the third antennas’ reading target area at least partially does not overlap with those of the first and second antennas, and that the reader/writer further reads article information stored in the RFID tag attached to the article by using the third antennas, wherein, for each RFID tag from which the reader/writer has read article information stored therein, the management device determines that the article to which the RFID tag is attached has been removed from or placed in the article storage based on the change in a reading status with regard to a reading of the RFID tag taken by using the third antennas, in addition to the change in the reading status with regard to respective readings of the RFID tag taken by using the first and second antennas.

This configuration can determine, for each RFID tag read by the reader/writer, that the article to which the tag is attached has been removed from and/or placed in the article storage based on the change in the reading status with regard to a reading of the RFID tag taken by using the third antennas, in addition to the reading status with regard to respective readings of the RFID tag taken by using the first and second antennas. As a result, the system is enabled to more reliably determine placement and/or removal of the article in and/or from the article storage.

A seventeenth aspect of the present invention is s the article management system of the sixteenth aspect, wherein the management device measures reception signal intensities of first and second signals received from each RFID tag by using the first antennas and the second antennas, respectively, and determines that the article to which the RFID tag is attached has been removed from the article storage when the reading status changes from a status in which the reception signal intensity of at least one of the first and third signals is higher than that of the second signal, to a status in which the reception signal intensity of at least one of the second and third signals is lower than that of the first signal, and determines that the article to which the RFID tag is attached has been placed in the article storage when the reading status changes from a status in which the reception signal intensity of at least one of the second and third signals is higher than that of the first signal, to a status in which the reception signal intensity of at least one of the first and third signals is lower than that of the second signal.

This configuration can determine a change in the reading status with regard to respective readings of an RIFD tag by using the first, second, and third antennas, based on reception signal intensities of first, second, and third signals received from each RFID tag by using the first antennas and the second antennas, respectively. Thus, the system can readily determine that the article to which the RFID tag is attached has been removed from or placed in the article storage based on the reception signal intensities of the first, second, and third signals received from each RFID tag by using the first, second, and third antennas, respectively.

An eighteenth aspect of the present invention is s the article management system of the sixteenth aspect, wherein the article storage includes: a hinged door to be used when the article is removed from or placed in the article storage; and an overhang extension located over the door, and wherein the third antennas are disposed on a lower surface of the overhang extension.

This configuration can read an RFID tag attached to an article, which is passing near the door when removal or placement of the article from and in the article storage, with the third antennas from an angle which is different from those of the first and second antennas. Thus, the configuration can minimize the formation of null points due to multipath, antennas’ orientations or other reasons, thereby improving the accuracy of readings of RFID tags.

A nineteenth aspect of the present invention is an article management method for determining movement of an article to which an RFID tag is attached, the article management method using a reader/writer which includes one or more first antennas provided on a side of a first prescribed region and one or more second antennas provided on a side of a second prescribed region such that the first antennas and the second antennas have respective reading target areas which at least partially do not overlap with each other, the method comprising: a first reading step in which the reader/writer reads article information stored in the RFID tag attached to the article by using the first antennas; a second reading step in which the reader/writer reads the article information stored in the RFID tag attached to the article by using the second antennas; and a determination step of determining, for each RFID tag from which the reader/writer has read article information stored therein, that a corresponding article to which the RFID tag is attached has been moved between the first prescribed region and the second prescribed region based on a change in a reading status with regard to respective readings of the RFID tag taken by using the first antennas and the second antennas.

This configuration can determine, for each RFID tag from which the reader/writer has read article information stored therein, that a corresponding article to which the RFID tag is attached has been moved between the first prescribed region and the second prescribed region based on a change in a reading status with regard to respective readings of the RFID tag taken by using the first antennas and the second antennas. As a result, the system is enabled to reliably determine a movement of an article to which an RFID tag is attached.

A twentieth aspect of the present invention is the article management method of the nineteenth aspect, wherein the determination step comprising: measuring reception signal intensities of first and second signals received from each RFID tag by using the first antennas and the second antennas, respectively, and determining that the article to which the RFID tag is attached has been moved from the first prescribed region to the second prescribed region when the reading status changes from a status in which the reception signal intensity of the first signal is higher than that of the second signal, to a status in which the reception signal intensity of the first signal is lower than that of the second signal.

This configuration can determine a change in the reading status with regard to respective readings of an RFID tag taken by using the first and second antennas, based on reception signal intensities of first and second signals received from each RFID tag by using the first antennas and the second antennas, respectively. Thus, the system can determine that the article to which the RFID tag is attached has been moved from the first prescribed region to the second prescribed region based on the reception signal intensities of the first and second signals received from each RFID tag by using the first antennas and the second antennas, respectively.

Embodiments of the present invention will be described below with reference to the drawings.

First, the present invention will be described with reference to cases where article management systems and article management methods of the present invention are applied to a self-checkout system (unmanned checkout system) in which shoppers make payment themselves. Although, in the present embodiment, the present invention is embodied in a self-checkout system, the article management system and the article management method may be applied to a cashier-staffed checkout system or a cashier-assisted checkout system.

### First Embodiment

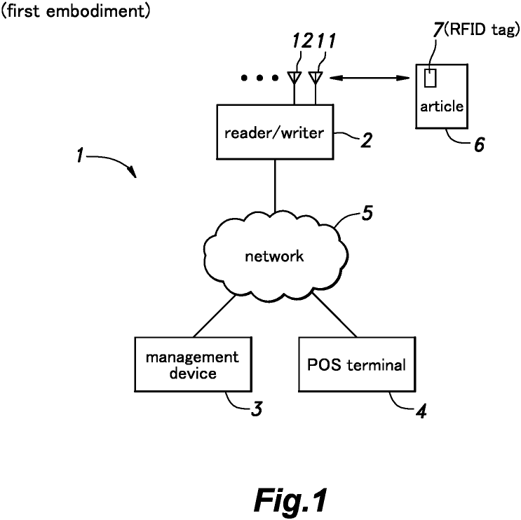

FIG. 1 is a diagram showing a general configuration of an article management system (hereinafter, also referred to as “checkout system”) according to a first embodiment of the present invention. As shown in FIG. 1, the checkout system 1 includes a reader/writer 2, a management device 3, and a POS terminal 4. The elements 2 to 4 of the checkout system 1 are connected to each other via a network 5.

The checkout system 1 uses RFID technology to read article information (hereinafter, also referred to as “item information”) from an RFID tag 7 attached to an article 6 (hereinafter, also referred to as “item 6”) purchased by a shopper, and the system 1, based on the article information, allows the shopper to make a payment for the article 6. Each RFID tag 7 (hereinafter, also simply referred to as “tag 7”) has a unique tag ID code and stores article information such as name of the article, price, and expiration date stored in association with the tag ID code.

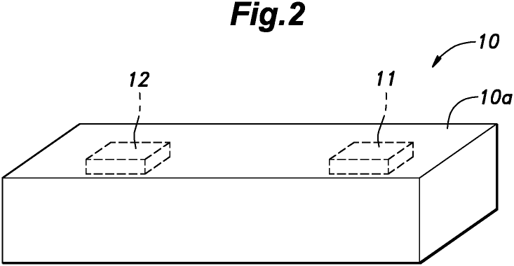

The reader/writer 2 includes a first antenna 11 and a second antenna 12. The first antenna 11 and the second antenna 12 are provided on a checkout counter 10 (see FIG. 2), on which a basket containing the article(s) 6 is placed for payment. When a shopper makes a payment for an article 6, the first antenna 11 and the second antenna 12 wirelessly communicate with a tag 7 attached to the article 6 to read the article information stored in the tag 7. The information read from the tag 7 by the first antenna 11 and the second antenna 12 is transmitted from the reader/writer 2 to the management device 3 via the network 5.

FIG. 2 is a perspective view showing the checkout counter 10 on which the first and second antennas are provided. As shown in FIG. 2, the first antenna 11 and the second antenna 12 are arranged on the upper surface 10a of the checkout counter 10 separately from each other by a predetermined distance so that radio waves from the first and second antennas do not interfere with each other. In other words, the first antenna 11 and the second antenna 12 are arranged so that their reading target areas for reading tags 7 do not overlap with each other. In the present embodiment, a tag 7 is a passive RFID tag which uses a frequency of the 920 MHz band (UHF band). The first antenna 11 and the second antenna 12 use a frequency in the 920 MHz band to read information from tags 7. It is desirable that the first antenna 11 and the second antenna 12 are circularly-polarized wave patch antennas from the viewpoint of directivity and polarization characteristics. However, the first antenna 11 and the second antenna 12 are not limited to the circularly-polarized patch antennas, and may be linearly-polarized antenna or other type of antennas.

The reader/writer 2 only have to have a function of reading information from tags 7, and a function of writing information in tags 7 is not essential. In the present embodiment, a single reader/writer 2 has the first antenna 11 and the second antenna 12. However, the checkout system may be configured to include two reader/writers 2; that is, a first reader/writer 2 including a first antenna 11 and a second reader/writer 2 including a second antenna 12. This configuration eliminates the need to switch between the first antenna 11 and the second antenna 12, and allows the first antenna 11 and the second antenna 12 to continuously read the information stored in a tag 7.

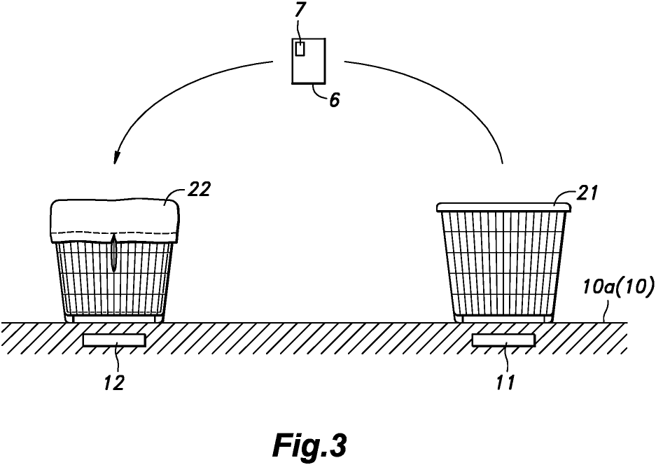

FIG. 3 is a diagram showing how a payment is made at the checkout counter 10 shown in FIG. 2. As shown in FIG. 3, when a shopper makes a payment for the article 6, a pre-payment basket 21 for containing articles for which payments are to be made is placed in a prescribed region (hereinafter referred to as “first prescribed region”) above the first antenna 11 on the upper surface 10a of the checkout counter 10, a post-payment basket 22 for containing articles for which payments have been made is placed in a prescribed region (hereinafter, referred to as “second prescribed region”) above the second antenna 12 on the upper surface 10a of the checkout counter 10.

The first antenna 11 and the second antenna 12 are arranged on the checkout counter 10 separately from each other by a predetermined distance so that radio waves from the first and second antennas do not interfere with each other. Thus, when an article 6 is in the pre-payment basket 21, the first antenna 11 can read a tag 7 attached to the article 6, but the second antenna 12 cannot (that is, the tag 7 can be read by using the first antenna 11, but cannot be read by using the second antenna 12). Similarly, when the article 6 is in the post-payment basket 22, the second antenna 12 can read the tag 7 attached to the article 6, but the first antenna 11 cannot.

At the time of payment for the article 6, a shopper (or a cashier) moves the article 6 from the pre-payment basket 21 to the post-payment basket 22. With the movement of the article 6, a reading status with regard to respective readings of article information stored in the tag 7 of the article 6 taken by using the first antenna 11 and the second antenna 12 (hereinafter, simply referred to as “reading status with regard to readings of the tag 7”), changes from a status in which the first antenna 11 can read the information, but the second antenna 12 cannot, to a status in which the second antenna 12 can read the information but the first antenna 11 cannot.

For the sake of simplification, FIG. 3 shows a case where one article 6 is moved from the pre-payment basket 21 to the post-payment basket 22. However, the same process is applied to cases where a plurality of articles 6 are moved from the pre-payment basket 21 to the post-payment basket 22. In such cases, for each article 6, a tag 7 attached to the article 6 is read by using the first antenna 11 or the second antenna 12.

In the present embodiment, it is assumed that the pre-payment basket 21 and the post-payment basket 22 are used. However, a plastic shopping bag, a shopper’s own shopping bag, and what is called an eco-bag may be used instead of the pre-payment basket 21 or the post-payment basket 22. In the example shown in FIG. 3, an unfolded shopper’s own bag is in the post-payment basket 22 after payment, readings of a tag 7 attached to an article 6 may be made by the first antenna 11 at a time when the article 6 is moved out of the pre-payment basket 21, and by the second antenna 12 at a time when the article 6 enters the post-payment basket 22. In other cases, an article 6 may be placed directly in the first prescribed region or the second prescribed region of the checkout counter 10 without using the pre-payment basket 21 and the post-payment basket 22.

The management device 3 is composed primarily of a server (computer) having a known configuration, and manages article information acquired from the reader/writer 2. As will be described in detail later, during payment for an article 6, the management device 3 determines whether or not the article has been purchased by determining whether or not a tag 7 of the article 6 is read by the first antenna 11 and the second antenna 12, respectively.

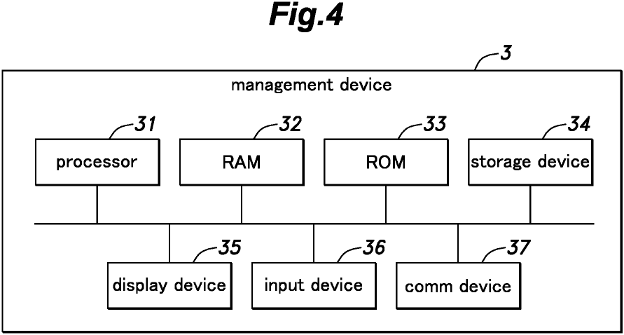

FIG. 4 is a block diagram showing a schematic configuration of the management device 3. The management device 3 includes: a processor 31 configured to collectively executes respective processing operations in the checkout system 1 based on predetermined control programs; a RAM 32, a volatile memory configured to function as a work area of the processor 31; a ROM 33, a non-volatile memory configured to store data and control programs executable by the processor 31; a storage device 34 having a memory space for storing programs and data necessary for the operations of the management device 3; a display device 35 having a monitor for displaying information necessary for users; and an input device 36 such as a keyboard and a mouse which enable users to perform entry operations; and a communication device 37 including a communication module which performs communications via the network 5.

In the hardware configuration shown in FIG. 4, each function of the management device 3 can be implemented by the processor 31 executing a predetermined control program. At least a part of the functions of the management device 3 may be replaced by processing operation performed by other known hardware.

The POS terminal 4 is a POS (Point Of Sales System) terminal device having known payment functions, and for an article 6 which has been determined by the management device 3 to have been purchased, the POS terminal 4 performs payment operations based on article information on the article 6.

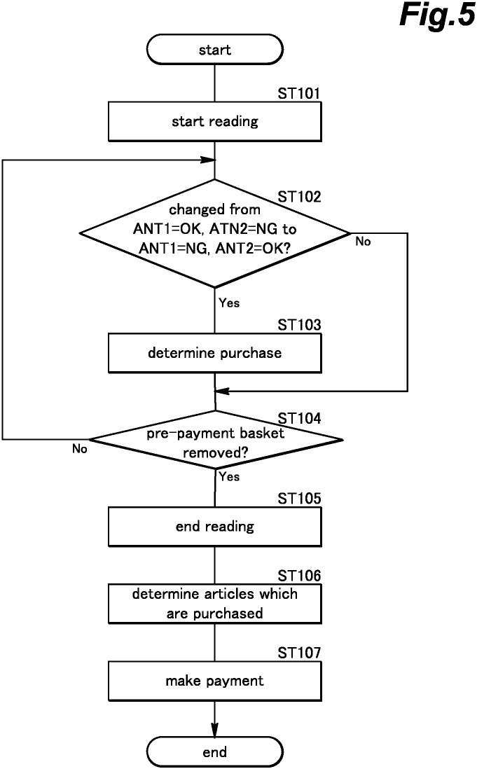

FIG. 5 is a flow chart illustrating a processing operation for determining purchase of an item (an article 6) performed by the management device 3. Referring to FIGS. 5 and 3, the processing operation for determining purchase of an article(s) 6 will be described. First, the management device 3 starts the operation when a shopper places the pre-payment basket 21 in the first prescribed region of the upper surface 10a of the checkout counter 10 during checkout of the article 6. Preferably, the placement of the pre-payment basket 21 in the first prescribed region is detected by an object sensor or a weight sensor provided near or beneath the first prescribed region. In the present embodiment, it is assumed that, during checkout, the post-payment basket 22 is placed in the second prescribed region of the upper surface 10a of the checkout counter 10.

When the placement of the pre-payment basket 21 in the first prescribed region is detected by the object sensor, weight sensor, or any other sensor, the management device 3 activates the reader/writer 2, and start a reading operation for reading a tag 7 of the article 6 with the use of the first antenna 11 and the second antenna 12 (step ST101). The reader/writer 2 may be activated by a shopper or a cashier by pressing a checkout start button.

Next, the management device 3 determines whether or not the reading status with regard to readings of the tag 7 has changed from a status in which the first antenna can read the tag 7 and the second antenna cannot (ANT1 = OK, ANT2 = NG), to a status in which the second antenna can read the tag 7 and the first antenna cannot (ANT1 = OK, ANT2 = NG) (step ST102). If the management device determines that such a change has occurred (Yes in step ST102), the process proceeds to the processing step ST103, and otherwise (No in step ST102), the process proceeds to step ST104.

In step ST103, the management device 3 determines that the article 6 to which the tag 7 is attached has been moved from the pre-payment basket 21 to the post-payment basket 22; that is, the article 6 has been purchased. In this situation, for example, if the POS terminal 4 is configured such that its display screen displays the number of articles which have been purchased by a shopper, and the displayed number is incremented each time the management device 3 determines purchase of an article, the POS terminal 4 can notify a shopper that each article 6 has been purchased.

As described with reference to FIG. 3, when a shopper (or a cashier) moves an article 6 from the pre-payment basket 21 to the post-payment basket 22 at a time of payment for the article 6, the reading status with regard to respective readings of the tag 7 taken by using the first antenna and the second antenna changes from a status in which the first antenna can read the tag 7 and the second antenna cannot, to a status in which the second antenna can read the tag 7 and the first antenna cannot. Therefore, when the reading status with regard to readings of a tag 7 has changed from a status in which the first antenna can read the tag 7 and the second antenna cannot (ANT1 = OK, ANT2 = NG), to a status in which the second antenna can read the tag 7 and the first antenna cannot (ANT1 = NG, ANT2 = OK), the management device 3 can determine that an article 6 to which the tag 7 is attached has been moved from the pre-payment basket 21 to the post-payment basket 22; that is, the article 6 has been purchased.

In the following step ST104, the management device 3 determines whether or not the pre-payment basket 21 has been removed from the first prescribed region. Preferably, the removal of the pre-payment basket 21 from the first prescribed region is detected by an object sensor or a weight sensor provided near or beneath the first prescribed region as in step ST101 described above. When the management device 3 determines that the pre-payment basket 21 has been removed from the first prescribed region (Yes in step ST104, the process proceeds to step ST105, and, when determining that the pre-payment basket 21 has not been removed from the first prescribed region (No in step ST104), the process returns to the previous step ST102 and the processing operations in ST102 and its subsequent steps are repeated.

In step ST105, the management device 3 turns off the reader/writer 2 (ends the operation of the reader/writer 2), and ends the reading operation for reading the tag 7 of the article 6 with the use of the first antenna 11 and the second antenna 12.

In the following step ST106, the management device 3 determines that the article 6 to which the tag 7 is attached has been purchased. As a result, the article(s) 6 purchased by a shopper is finally determined.

Then, in step ST107, the POS terminal 4 performs operations to make payments for the articles 6 determined to be purchased.

As described above, the checkout system according to the first embodiment of the present invention can determine that an article 6 to which a tag 7 is attached has been moved from the pre-payment basket 21 to the post-payment basket 22; that is, the article 6 has been purchased, based on a change in a reading status with regard to respective readings of the tag 7 taken by using the first antennas 11 and the second antennas 12. This enables reduction of the rate of incorrect readings of RFID tags when RFID technology is used in checkout of articles. In addition, the system can readily determine the change in the reading status with regard to respective readings of the tag 7 taken by using the first antennas 11 and the second antennas 12, based on the presence or absence of the respective readings of the tag 7 taken by using the first antennas 11 and the second antennas 12 (refer to Step ST102).

Moreover, the reader/writer 2 is activated when the pre-payment basket 21 is placed in the first prescribed region and does not read tags 7 other than at times payments are made, which enables further reduction of the rate of incorrect readings of tags 7.

In the present embodiment, the first antenna 11 and the second antenna 12 are arranged so that their reading target areas for reading tags 7 do not overlap with each other. However, the first antenna 11 and the second antenna 12 may be arranged so that their reading target areas for reading tags 7 partially overlap with each other.

### First Variation of First Embodiment

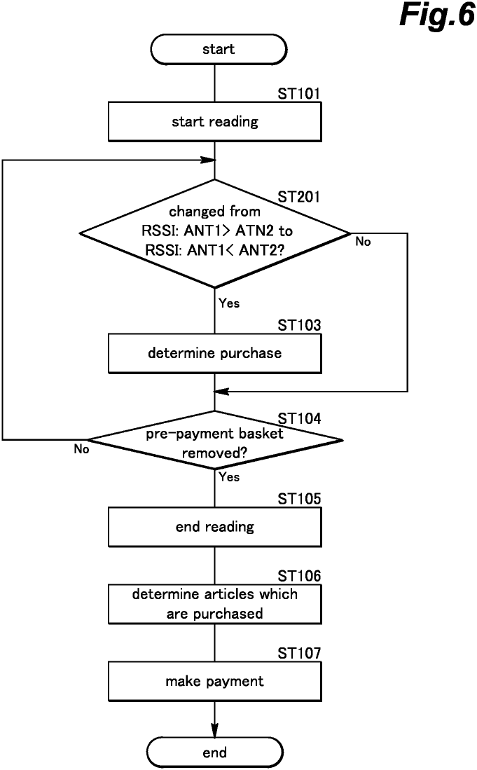

In the first embodiment described above, the system is configured to determine the change in the reading status with regard to respective readings of a tag 7 taken by using the first antennas 11 and the second antennas 12, based on the presence or absence of the respective readings of the tag 7 taken by using the first antennas 11 and the second antennas 12. However, the reading status may be determined based on Receive Signal Strength Indications (RSSIs), which indicate reception strengths of first and second signals received from a tag 7 by using the first antenna 11 and the second antenna 12, respectively. In this case, as shown in FIG. 6, step ST201 is provided in the processing operation instead of step ST102 shown in FIG. 5.

In Step ST201, the management device 3 determines whether or not the reading status with regard to Receive Signal Strength Indications (RSSIs) of first and second signals received from the tag 7 by using the first antenna 11 and the second antenna 12, respectively, has changed from a status in which the RSSI of the first signal from the first antenna 11 (ANT1) is higher than the RSSI of the second signal from the second antenna 12 (ANT2) (RSSI: ANT1> ANT2), to a status in which the RSSI of the first signal from the first antenna 11 (ANT1) is lower than the RSSI of the second signal from the second antenna 12 (ANT2) (RSSI: ANT1< ANT2). If the management device determines that such a change has occurred (Yen in step ST201), the process proceeds to the processing step ST103, and otherwise (No in step ST201), the process returns to step ST102.

In step ST103, the management device 3 determines that an article 6 to which the tag 7 is attached has been moved from the pre-payment basket 21 to the post-payment basket 22; that is, the article 6 has been purchased.

As shown in FIG. 3, when the article 6 is in the pre-payment basket 21, the article 6 is located above the first antenna 11 (ANT1), and thus the RSSI of the first signal from the first antenna 11 (ANT1) is higher than the RSSI of the second signal from the second antenna 12 (ANT2). When the article 6 is the post-payment basket 22, the article 6 is located above the second antenna 12 (ANT2), and thus the RSSI of the second signal from the second antenna 12 (ANT2) is higher than the RSSI of the first signal from the first antenna 11 (ANT1).

Therefore, when the reading status with regard RSSIs of signals received from a tag 7 has changed from a status in which the RSSI of the first signal from the first antenna 11 (ANT1) is higher than the RSSI of the second signal from the second antenna 12 (ANT2) (RSSI: ANT1> ANT2), to a status in which the RSSI of the first signal from the first antenna 11 (ANT1) is lower than the RSSI of the second signal from the second antenna 12 (ANT2) (RSSI: ANT1< ANT2), the management device 3 can determine that an article 6 to which the tag 7 is attached has been moved from the pre-payment basket 21 to the post-payment basket 22; that is, the article 6 has been purchased.

### Second Variation of First Embodiment

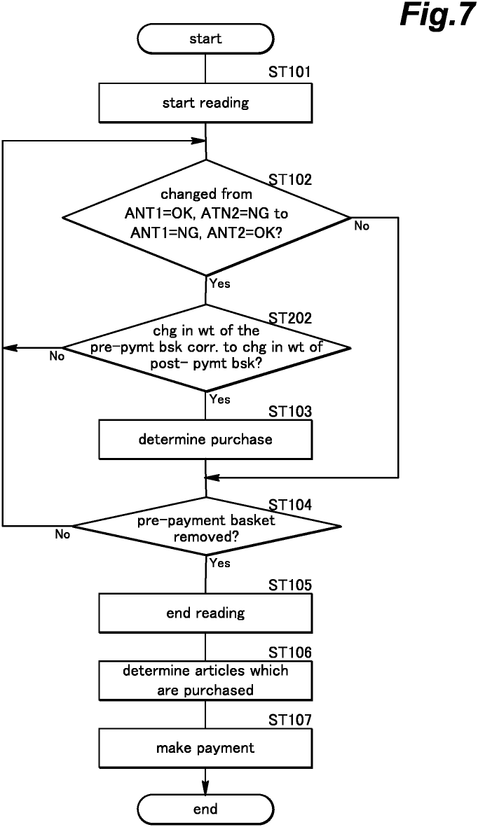

The system may be configured such that, after article information stored in a tag 7 is read by using the first antennas 11 and the second antennas 12, the system determines if an article 6 to which the tag 7 is attached has been moved from the pre-payment basket 21 to the post-payment basket 22. In this case, as shown in FIG. 7, step ST202 is provided between step ST102 and step ST103 in the processing operation.

In step ST202, the management device 3 determines whether or not a change in weight of the pre-payment basket 21 (decrease in weight) corresponds to a change in weight of the post-payment basket 22 (increase in weight). Preferably, the change in weight of the pre-payment basket 21 is measured by a first weight sensor provided below the first prescribed region where the pre-payment basket 21 is placed, and the change in weight of the post-payment basket 22 is measured by a second weight sensor provided below the second prescribed region where the post-payment basket 22 is placed.

In step ST202, if the management device 3 determines that a change in weight of the pre-payment basket 21 corresponds to a change in weight of the post-payment basket 22, (Yes in step ST202), the process proceeds to step ST103, and otherwise (No in step ST202), the process returns to the step ST102.

That is, the management device 3 can determine a decrease in weight of the pre-payment basket 21 (i.e., the weight of an article removed from the pre-payment basket 21) by comparison between the weights measured before and after the removal of the article. Similarly, the management device 3 can determine an increase in weight of the post-payment basket 22 (i.e., the weight of an article placed in the post-payment basket 22) by comparison between the weights measured before and after the placement of the article. When the weight of an article removed from the pre-payment basket 21 corresponds to that placed in the post-payment basket 22, the management device 3 can determine that the article has been purchased (moved from the pre-payment basket 21 to the post-payment basket 22).

In this configuration, the management device 3 can determine that an article 6 has been purchased only when determining that the article has been moved from the pre-payment basket 21 to the post-payment basket 22, which enables further reduction of the rate of incorrect readings of tags 7.

### Third Variation of First Embodiment

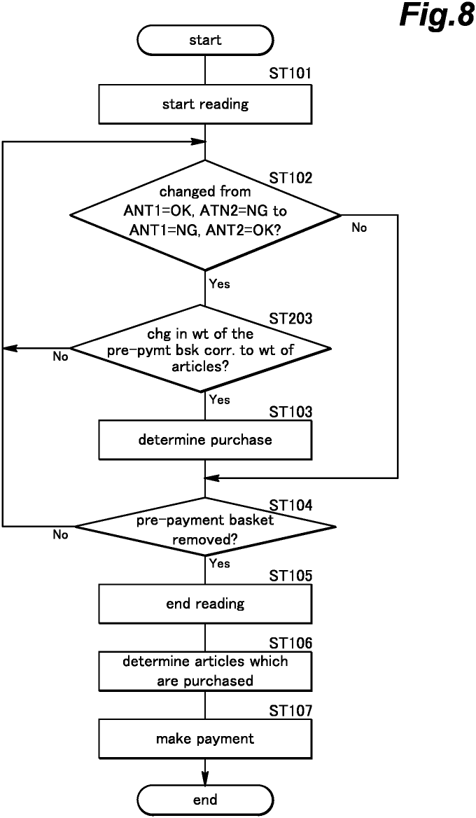

The system may be configured to use the weight of an article 6 stored in a tag 7 attached to the article 6 when determining that the article 6 has been moved from the pre-payment basket 21 to the post-payment basket 22. In this case, as shown in FIG. 8, step ST203 is provided between step ST102 and step ST103 in the processing operation. In addition, it is assumed that article information stored in a tag 7 includes the weight of an article 6 to which the tag 7 is attached. Therefore, when article information on an article 6 is read by using the first antennas 11 or the second antennas 12, the system can also read the weight of the article 6.

In step ST203, the management device 3 determines whether or not a change in weight of the pre-payment basket 21 (decrease in weight) corresponds to the weight of an article 6 included in article information read from the tag 7 attached to the article 6 by using the first antennas 11 or the second antennas 12. Preferably, the change in weight of the pre-payment basket 21 is measured by a weight sensor provided below the first prescribed region where the pre-payment basket 21 is placed.

In step ST203, if the management device 3 determines that a change in weight of the pre-payment basket 21 corresponds to the weight of the article 6, (Yes in step ST203), the process proceeds to step ST103, and otherwise (No in step ST203), the process returns to the step ST102.

In this configuration, the management device 3 can determine that an article 6 has been moved based on a change in weight of the pre-payment basket 21 and the weight of the article 6 stored in the tag 7 attached to the article 6. In addition, with regard to weight sensors, the system requires only one weight sensor provided below the first prescribed region where the pre-payment basket 21 is placed. Thus, the configuration can be made simple as compared to that of the above- described second variation using two weight sensors.

The system according to the above-described third variation may be modified to use, in place of a change in weight of the pre-payment basket 21 (decrease in weight), a change in weight of the post-payment basket 22 (increase in weight). Preferably, the change in weight of the post-payment basket 22 is measured by a weight sensor provided below the second prescribed region where the post-payment basket 22 is placed.

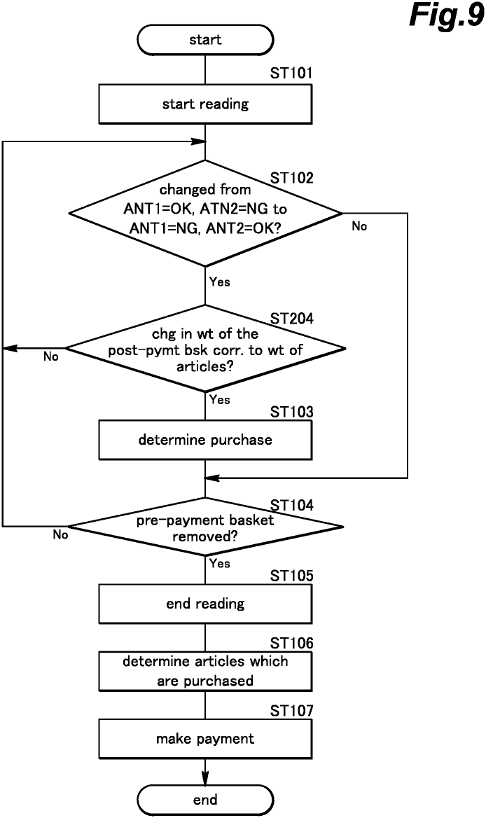

In this case, as shown in FIG. 9, step ST204 is in place of step ST203. In step ST204, the management device 3 determines whether or not a change in weight of the post-payment basket 22 (increase in weight) corresponds to the weight of an article 6 included in article information read from a tag 7 attached to the article 6 by using the first antennas 11 or the second antennas 12.

In step ST204, if the management device 3 determines that a change in weight of the post-payment basket 22 corresponds to the weight of the article 6, (Yes in step ST204), the process proceeds to step ST103, and otherwise (No in step ST204), the process returns to the step ST102.

In this configuration, the management device 3 can determine that an article 6 has been moved based on a change in weight of the post-payment basket 22 and the weight of the article 6 stored in a tag 7 attached to the article 6. In addition, with regard to weight sensors, the system requires only one weight sensor provided below the second prescribed region where the post-payment basket 22 is placed. Thus, the configuration can be made simple as compared to that of the above- described second variation using two weight sensors.

### Second Embodiment

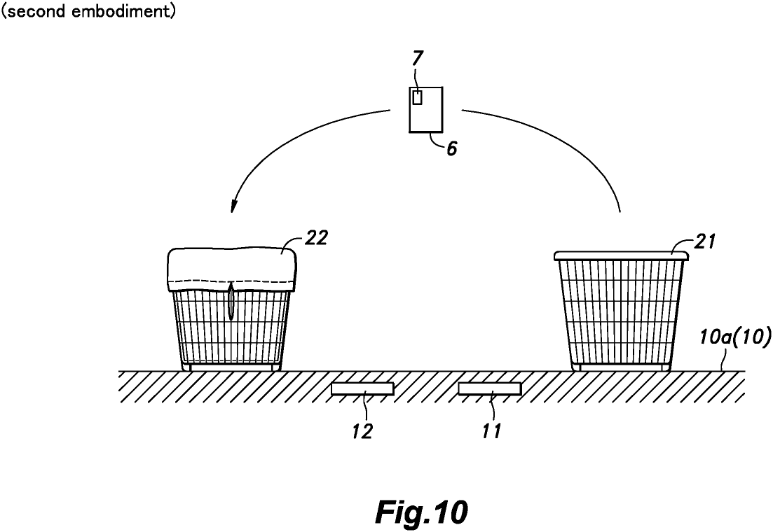

FIG. 10 is a diagram showing a system according to a second embodiment, in a similar situation to that of the first embodiment shown in FIG. 3. Except for what will be discussed here, this embodiment is the same as the above-described first embodiment and detailed descriptions related thereto will be omitted. In FIG. 10, like reference numerals refer to like parts or elements in the first embodiment.

In the second embodiment, the first antenna 11 and the second antenna 12 are located between the first prescribed region where the pre-payment basket 21 is placed and the second prescribed region where the post-payment basket 22 is placed. In the example of FIG. 10, the first antenna 11 is provided at a location adjacent to the first prescribed region, and the second antenna 12 is provided at a location adjacent to the second prescribed region.

In the second embodiment, a tag 7 of an article 6 is read while the article 6 is moved from the pre-payment basket 21 to the post-payment basket 22, not when the article 6 is in the pre-payment basket 21 or the post-payment basket 22. Specifically, the tag 7 of the article 6 is read by using the first antenna 11 immediately after the article 6 is taken out of the pre-payment basket 21, and then, the tag 7 is read by using the second antenna 12 right before being put into the post-payment basket 22. One or more shielding plates may be provided between the first antenna 11 and the second antenna 12.

In this configuration, even though the first antenna 11 and the second antenna 12 are located between the first prescribed region and the second prescribed region, the management device 3 can read a tag 7 of an article 6 by using the first antenna 11 and the second antenna 12 when the article 6 is moved from the pre-payment basket 21 to the post-payment basket 22, in the same manner as the first embodiment. Therefore, the system can achieve the same technical effects as the above-described first embodiment.

### Third Embodiment

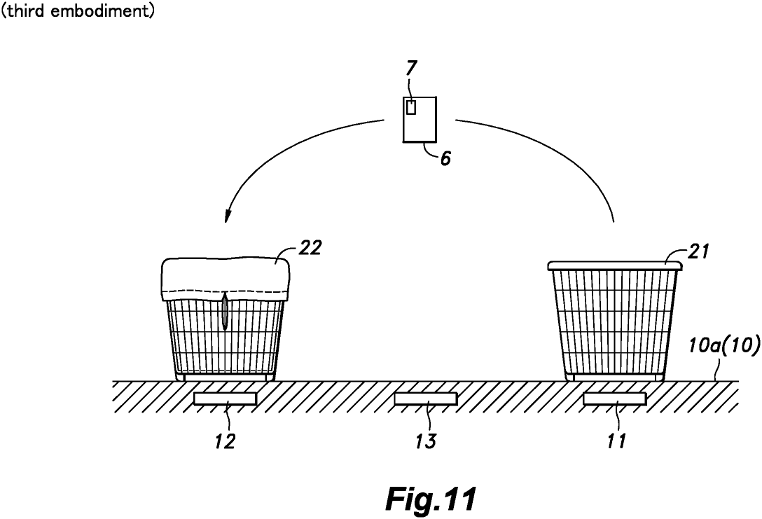

FIG. 11 is a diagram showing a system according to a third embodiment, in a similar situation to that of the first embodiment shown in FIG. 3. Except for what will be discussed here, this embodiment is the same as the above-described first and second embodiments and detailed descriptions related thereto will be omitted. In FIG. 11, like reference numerals refer to like parts or elements in the first and second embodiments.

In the third embodiment, a third antenna 13 is additionally provided between the first antenna 11 and the second antenna 12. The third antenna 13 is arranged such that its reading target area for reading tags 7 at least partially does not overlap with those of the first and second antennas. Like the first antenna 11 and the second antenna 12, the third antenna 13 is also an antenna of the reader/writer 2, and capable of reading article information stored in each tag 7. In other cases, the first antenna 11 and the second antenna 12 may be located between the first prescribed region and the second prescribed region as in the second embodiment.

In the third embodiment, a tag 7 of an article 6 is further read by the third antenna 13 during the article 6 is being moved from the pre-payment basket 21 to the post-payment basket 22, in addition to when the article 6 is in the pre-payment basket 21 and when in the post-payment basket 22.

In the third embodiment, the management device 3 can determine that an article 6 to which a tag 7 is attached has been purchased only when determining that the reading status changes from a status in which the first antenna 11 can read the tag 7 but the third antenna 13 cannot (i.e. the article 6 is in the pre-payment basket 21), to a status in which the first antenna 11 cannot read the tag 7, but the third antenna can read the tag 7 (i.e. the article 6 has been taken out of the pre-payment basket 21 and moved near the third antenna 13), and subsequently, the reading status changes from a status in which the third antenna 13 can read the tag 7, but the second antenna 12 cannot read the tag (i.e. the article 6 is located near the third antenna 13 and has not been moved to the post-payment basket 22), to a status in which the third antenna 13 cannot read the tag 7, but the second antenna 12 can read the tag (i.e. the article 6 has been moved to the post-payment basket 22).

In this configuration, the system can further reliably determine whether or not an article 6 to which a tag 7 is attached has been purchased (i.e., whether or not the article 6 has been moved from the pre-payment basket 21 to the post-payment basket 22), based on the change in the reading status with regard to a reading of the tag 7 taken by using the third antenna 13 provided between the first and second antennas, in addition to the change in the reading status with regard to respective readings of the tag 7 taken by using the first antenna 11 and the second antenna 12.

Furthermore, in the same manner as in the first variation of the first embodiment, the system may be configured to determine the changes in the reading status with regard to respective readings of a tag 7 taken by using the first, second, and third antennas 11, 12, 13, based on respective Receive Signal Strength Indications (RSSIs), which indicate respective reception strengths of first, second, and third signals received from the tag 7 by using the first, second, and third antennas 11, 12, 13, respectively.

In this configuration, the management device 3 can determine that an article 6 to which a tag 7 is attached has been purchased only when determining that the reading status with regard to Receive Signal Strength Indications (RSSIs) of first, second, and third signals received from the tag 7 by using the first, second, and third antenna 11, 12, 13, respectively, has changed from a status in which the RSSI of the first signal from the first antenna 11 is higher than the RSSI of the third signal from the third antenna 13, to a status in which the RSSI of the first signal from the first antenna 11 is lower than the RSSI of the third signal from the third antenna 13, and then further changed from a status in which the RSSI of the third signal from the third antenna 13 is higher than the RSSI of the second signal from the second antenna 12, to a status in which the RSSI of the third signal from the third antenna 13 is lower than the RSSI of the second signal from the second antenna 12.

In this configuration, the system can further reliably determine whether or not an article 6 to which a tag 7 is attached has been purchased based on the RSSIs of the first, second, and third signals receive from the tag 7 by using the first, second, and third antennas 11, 12, 13, respectively.

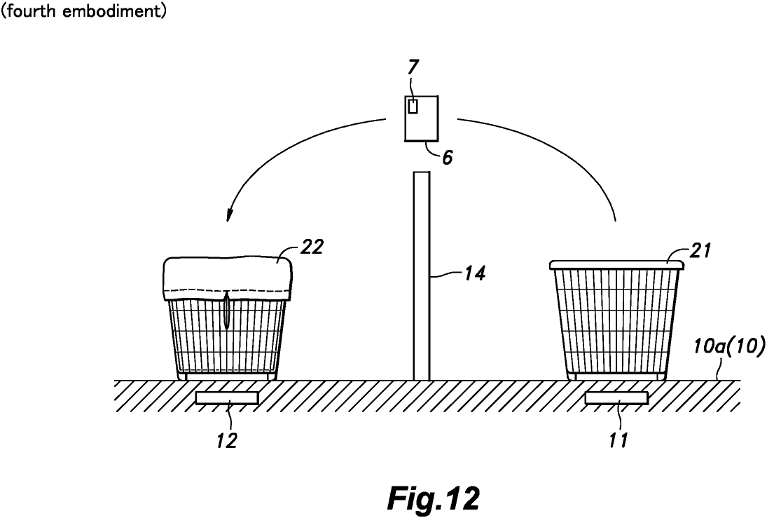

FIG. 12 is a diagram showing a system according to a fourth embodiment, in a similar situation to that of the first embodiment shown in FIG. 3. Except for what will be discussed here, this embodiment is the same as the above-described first and third embodiments and detailed descriptions related thereto will be omitted. In FIG. 12, like reference numerals refer to like parts or elements in the first and third embodiments.

In the fourth embodiment, a shielding plate 14 is provided between the first antenna 11 and the second antenna 12 for shielding radio waves emitted from the first and second antennas 11, 12. The shielding plate 14 is formed of either or both of a metal plate and a radio wave absorbing material. The shielding plate 14 is preferably configured to include a metal plate and a radio wave absorbing material provided on both sides of the metal plate so that the radio wave absorbing material can reduce the reflection of the radio waves while the metal plate can prevent the transmission of the radio waves, thereby reducing leakage of radio waves from each prescribed region where tag information is read from an RFID tag.

In this configuration, the shielding plate 14 can inhibit the first antenna 11 and the second antenna 12 from reading articles in the second prescribed region and the first prescribed region, respectively. This enables further reduction of the rate of incorrect readings of tags 7.

In each of the above-described first, second, third, and fourth embodiments, the system may include two or more first antennas 11, two or more second antennas 12, and/or two or more third antennas 13. This configuration, in which multiple first, second, and/or third antennas are provided, enables more reliable readings of tags, thereby decreasing the rate of incorrect readings of tags and increasing the rate of correct readings of tags. Moreover, the system may be configured such that shielding plates are provided between the first, second, and third antennas 11, 12, and 13. This configuration can decrease leakage of radio waves between the first, second, and third antennas, thereby further reducing the rate of incorrect readings of tags.

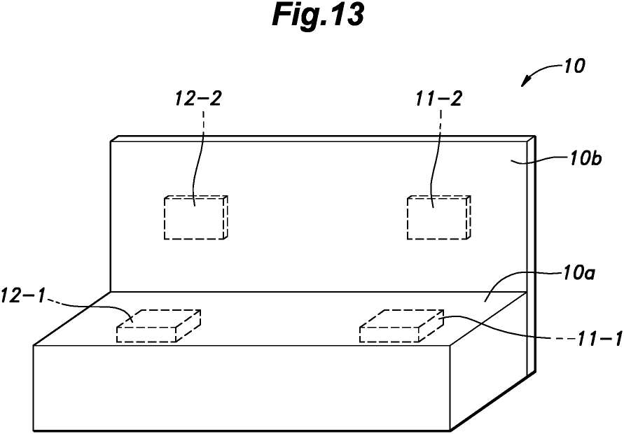

FIG. 13 is a diagram showing a checkout counter 10 on which pluralities of first and second antennas 11, 12 are provided, in the system of the first embodiment. In the example shown in FIG. 13, the checkout counter 10 includes an upper surface 10a and a side plate 10b.

In the first embodiment, when the pluralities of first antennas 11 and second antennas 12 are provided, the both sets of antennas may be provided on the upper surface 10a and the side plate 10b of the checkout counter 10 as shown in FIG. 13. In the example shown in FIG. 13, the two first antennas 11, i.e., the first antennas 11-1 and 11-2, are provided on the upper surface 10a and the side plate 10b of the checkout counter 10, respectively. Similarly, the two second antennas 12, i.e., the second antennas 12-1 and 12-2, are provided on the upper surface 10a and the side plate 10b of the checkout counter 10, respectively.

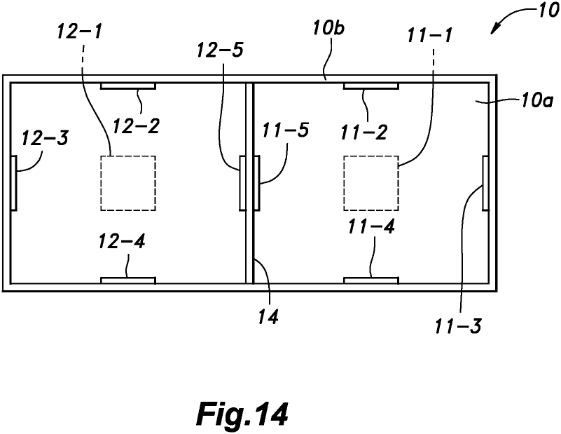

FIG. 14 is a diagram showing a top view of a checkout counter 10 on which pluralities of first and second antennas 11, 12 are provided, in the system of the fourth embodiment. In the example of FIG. 14, the checkout counter 10 includes an upper surface 10a and four frame-shaped side plates 10b surrounding the peripheral edge of the upper surface 10a. A side plate 10b is preferably formed of either or both of a metal plate and a radio wave absorbing material, similarly to the shielding plate 14. It is more preferable that the radio wave absorbing material is provided on a surface of the metal plate because the radio wave absorbing material can reduce the reflection of the radio waves while the metal plate can prevent the transmission of the radio waves, enabling the reduction of leakage of radio waves from each prescribed region where tag information is read from tags.

In the fourth embodiment, when the pluralities of first antennas 11 and second antennas 12 are provided, the both sets of antennas may be provided on the upper surface 10a and the side plates 10b of the checkout counter 10 and the shielding place 14, as shown in FIG. 14. In the example shown in FIG. 14, the five first antennas 11 are provided such that the first antenna 11-1 and the first antennas 11-2 to 11-4 are provided on the upper surface 10a and the side plates 10b of the checkout counter 10, respectively, and the first antenna 11-5 is provided on the shielding plate 14. Similarly, the five second antennas 12 are provided such that the second antenna 12-1 and the second antennas 12-2 to 12-4 are provided on the upper surface 10a and the side plates 10b of the checkout counter 10, respectively, and the second antenna 12-5 is provided on the shielding plate 14.

Although not shown in the figures, the pluralities of first and second antennas can be provided in the second and third embodiments in a similar manner. In such cases, each set of the first and second antennas are preferably provided on the upper surface 10a and the side plate(s) 10b of the checkout counter 10 and or the shielding plate 14.

Next, the present invention will be described with reference to cases where article management systems and article management methods of the present invention are applied to the management of removal of an item (an article) from a refrigeration storage in an unmanned store system in the form of refrigerator. Although, in the present embodiment, the storage is a refrigeration storage, any other type of storage may be used as an article storage. In an unmanned store system in the form of refrigerator according to the present embodiment, a refrigeration storage stores various articles such as foods and daily necessities to which RFID tags are attached, and shoppers can take out or remove desired articles from the refrigeration storage and purchase them. A reader/writer reads RFID tag attached to the articles by using its antennas to thereby identify the articles the shoppers have taken out. Then, the shoppers can make payments themselves for the articles by using a checkout terminal provided on the door of the refrigeration storage.

### Fifth Embodiment

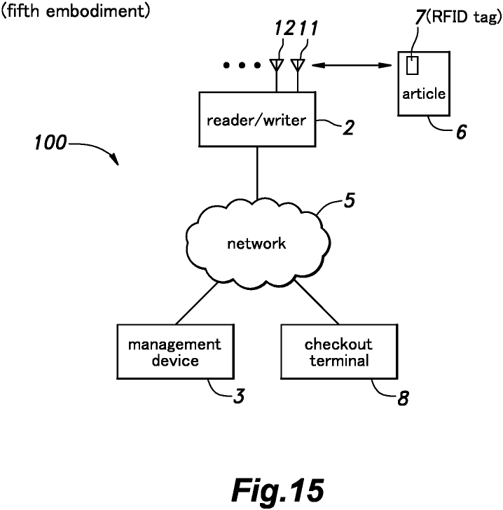

FIG. 15 is a diagram showing a system of a fifth embodiment of the present invention, which corresponds to that of the first embodiment shown in FIG. 1. Except for what will be discussed here, this embodiment is the same as the above-described first embodiment and detailed descriptions related thereto will be omitted. In FIG. 15, like reference numerals refer to like parts or elements in the first embodiment.

FIG. 15 is a diagram showing a general configuration of an article management system 100 according to the fifth embodiment of the present invention. As shown in FIG. 15, the article management system 100 includes a reader/writer 2, a management device 3, and a checkout terminal 8. These elements 2, 3 and 8 of the article management system 100 are connected to each other via a network 5.

The reader/writer 2 includes a first antenna 11 and a second antenna 12 which can wirelessly communicate with tags 7 attached to articles 6 to read article information (item information) stored in the respective tags 7. Each tag 7 has a unique tag ID code and stores article information such as name of the article, price, and expiration date stored in association with the tag ID code. The information read from the tag 7 by the reader/writer 2 is transmitted from the reader/writer 2 to the management device 3 via the network 5.

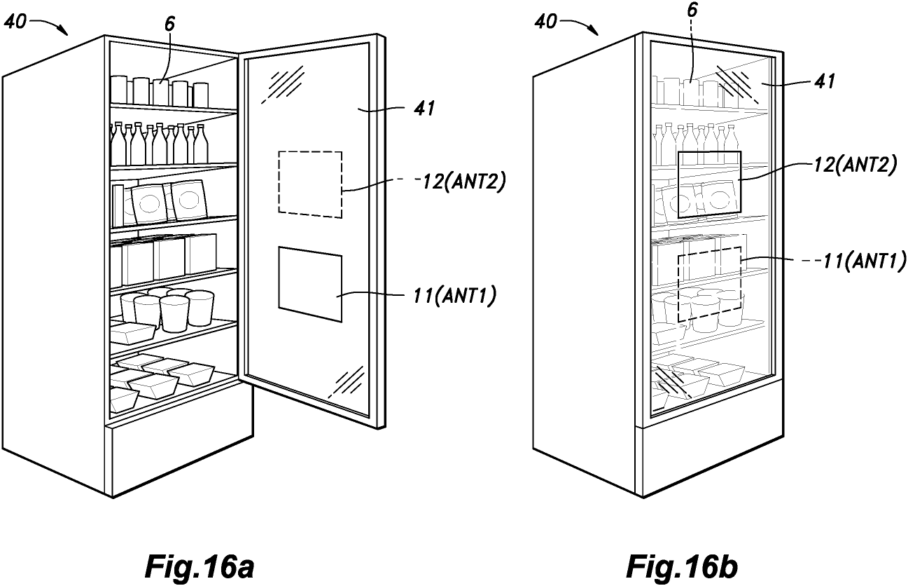

The article management system 100 of the present invention includes an article storage 40 in a form of a refrigerator. FIG. 16 illustrates the article storage 40 of the article management system 100, in which FIG. 16A is a perspective view of the article storage 40 with its door 41 open, and FIG. 16B is a perspective view of the article storage 40 with its door 41 closed. In the present embodiment, a space or region inside the article storage 40 corresponds to the first prescribed region, and a space or region outside the article storage 40 corresponds to the second prescribed region.

As shown in FIG. 16, the article storage 40 has a hinged door 41 which is used when a shopper takes out an article 6 from the article storage 40. The first antenna 11 (ANT1) of the reader/writer 2 is provided on the inner surface of the door 41. The second antenna 12 (ANT2) of the reader/writer 2 is provided on the outer surface of the door 41. The inner surface of the door 41 is a surface of the door 41 which faces the inside of the article storage 40 when the door 41 is closed. The outer surface of the door 41 is a surface of the door 41 which faces the outside of the article storage 40 when the door 41 is closed. Therefore, the first antenna 11 is located closer to the article storage than the second antenna 12.

In FIG. 16, the first antenna 11 and the second antenna 12 are arranged on the door 41 so as to be offset from each other in the vertical direction. However, the arrangement of the antennas are not limited to this, and the first antenna 11 and the second antenna 12 may be arranged on the door 41 so as to at least partially overlap with each other in the vertical direction and/or horizontal direction.

The door 41 of the article storage 40 may be formed of a transparent electromagnetic shielding material or a transparent radio wave absorbing material. When the door 41 is formed of an electromagnetic shielding material or a radio wave absorbing material, the isolation can secured between the first antenna 11 and the second antenna 12. Thus, this configuration can prevent the first antenna 11 on the inner surface of the door 41 from reading tags 7 located outside of the article storage 40, and also prevent the second antenna 12 on the outer surface of the door 41 from reading tags 7 located inside of the article storage 40. As a result, the accuracy of readings of tags 7 can be improved. When the door 41 is made transparent, shoppers are enabled to visually recognize articles 6 in the article storage 40 from the outside through the door 41.

The first antenna 11 and the second antenna 12 may be made of transparent electrically conductive material such as transparent electrically conductive films. This configuration enables users to easily see articles 6 stored in the article storage 40.

The portion of a housing of the article storage 40 other than the door 41 may be made of a metal material. Since metal materials are not transparent to radio waves, this configuration can more reliably secure the isolation between the first antenna 11 and the second antenna 12 when the door 41 is closed. As a result, the accuracy of readings of tags 7 can be further improved.

The door 41 of the article storage 40 is provided with a locking mechanism (not shown) and configured to be automatically locked when closed. The locking mechanism of the door 41 is connected to the checkout terminal 8 via the network 5. When purchasing an article 6 stored in the article storage 40, a shopper actives an unlocking function of the checkout terminal 8 described later to unlock the door 41, thereby opening the door 41. When a shopper finishes the purchase (shopping) and closes the door 41, the door 41 is automatically locked again. Furthermore, the locking mechanism of the door 41 is connected to the management device 3 via the network 5. When the door 41 is unlocked, the locking mechanism of the door 41 transmits an unlock signal to the management device 3, and when the door 41 is locked again, the locking mechanism of the door 41 transmits a door locking signal to the management device 3.

The management device 3 is composed primarily of a server (computer) having a known configuration, and is configured to manage article information acquired from the reader/writer 2 and determine that an article 6 to which a tag 7 is attached has been moved from the inside to the outside of the article storage 40; that is, determine that the article 6 has been removed from the article storage, based on a change in a reading status at the reader/writer 2 with regard to respective readings of the tag 7 taken by using the first antenna 11 and the second antenna 12.

The checkout terminal 8 is a terminal device having a known checkout function, and is installed on the door 41 of the article storage 40 although the location of the checkout terminal 8 is not limited to this. After taking out an article 6 from the article storage 40, a shopper can make payment themselves for the article by using the checkout function of the checkout terminal 8. Payment is made for the article 6 based on its article information, by using activation means such as an IC card, a credit card, or an electronic money app installed in a smartphone.

The checkout terminal 8 has, in addition to the above checkout function, an unlocking function for allowing a shopper to unlock the door 41 of the article storage 40 by using activation means such as an IC card, a display function for displaying article information (such as article name, price, and expiration date) of the article 6 taken out from the article storage 40, and a confirmation function for allowing a shopper to confirm the purchase of the article. Preferably, the display function and the confirmation function are made usable through a touch panel display screen, for example. Also, preferably, payments enabled by the checkout function of the checkout terminal 8 are automatically made when the purchase of an article 6 is confirmed through the confirmation function.

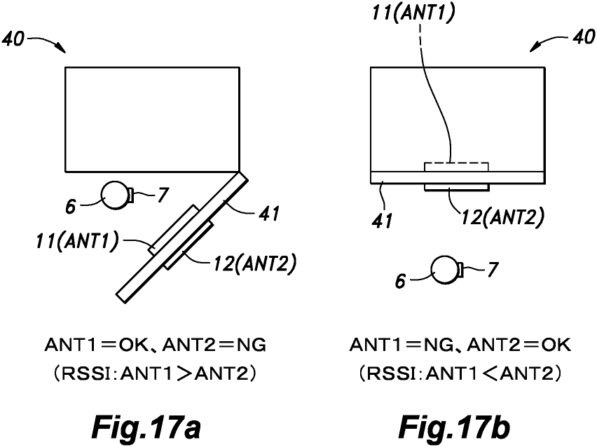

FIG. 17 illustrates how the door 41 is moved when an article 6 is removed from the article storage 40, in which FIG. 17A is a top view of the article storage 40 with its door 41 open, and FIG. 17B is a top view of the article storage 40 with its door 41 closed.

As shown in FIG. 17A, when a shopper starts removal of an article 6 from the article storage 40, the door 41 of the article storage 40 is opened, and the article 6 removed from the article storage 40 passes in front of the inner surface of the opened door 41. In this situation, a tag 7 attached to the article 6 is read by using the first antenna 11 (ANT1) provided on the inner surface of the door 41 (ANT1 = OK). Since the door 41 is formed an electromagnetic shielding material or a radio wave absorbing material and is not transparent to radio waves, the tag 7 attached to the article 6 cannot be read by using the second antenna 12 (ANT2) provided on the outer surface of the door 41 (ANT2 = NG).

As shown in FIG. 17B, when a shopper finishes removal of an article 6 from the article storage 40, the door 41 of the article storage 40 is closed, and the article 6 removed from the article storage 40 passes in front of the outer surface of the opened door 41. In this situation, a tag 7 attached to the article 6 is read by using the second antenna 12 (ANT2) provided on the outer surface of the door 41 (ANT2 = OK). Since the door 41 is formed an electromagnetic shielding material or a radio wave absorbing material and is not transparent to radio waves, the tag 7 attached to the article 6 cannot be read by using the first antenna 11 (ANT1) provided on the outer surface of the door 41 (ANT1 = NG).

As described above, when a shopper removes an article 6 from the article storage 40, the reading status with regard to respective readings of a tag 7 of the article 6 taken by using the first antenna 11 and the second antenna 12 changes from a status as shown in FIG. 17A in which the first antenna 11 can read the tag 7 and the second antenna 12 cannot (ANT1 = OK, ANT2 = NG), to a status as shown in FIG. 17B in which the second antenna 12 can read the tag 7 and the first antenna cannot (ANT1 = NG, ANT2 = OK).

For the sake of simplification, FIG. 17 shows a case where one article 6 is removed from the article storage 40. However, the same process is applied to cases where a plurality of articles 6 are removed from the article storage 40. In such cases, for each article 6, the reading status with regard to respective readings of a tag 7 of the article 6 taken by using the first antenna 11 and the second antenna 12 changes from a status as shown in FIG. 17A to a status as shown in FIG. 17B.

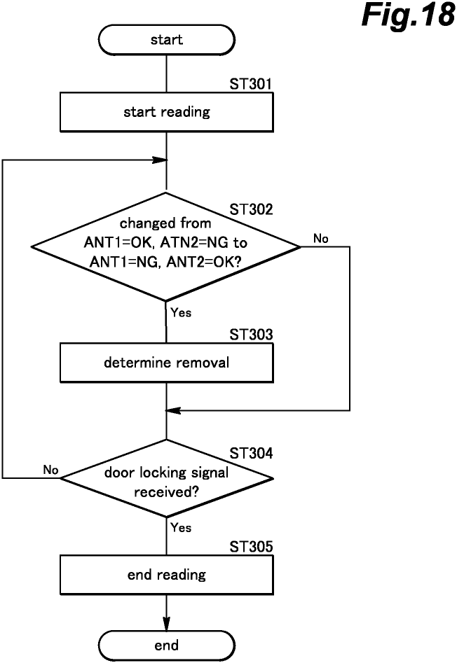

FIG. 18 is a flow chart illustrating a processing operation for determining removal of an article 6 from an article storage 40, performed by the management device 3. Referring to FIGS. 18 and 17, the processing operation for determining removal of an article(s) 6 will be described. First, the management device 3 starts the operation when a shopper activates an unlocking function of the checkout terminal 8, to thereby unlock the door 41 of the article storage 40. As described above, when the door 41 of the article storage 40 is unlocked, the locking mechanism of the door 41 transmits an unlock signal to the management device 3.

Upon receiving the unlock signal from the locking mechanism of the door 41, the management device 3 activates the reader/writer 2, and starts a reading operation for reading the tag 7 of the article 6 with the use of the first antenna 11 and the second antenna 12 (step ST301).

Next, the management device 3 determines whether or not the reading status with regard to readings of the tag 7 has changed from a status in which the first antenna can read the tag 7 and the second antenna cannot (ANT1 = OK, ANT2 = NG), to a status in which the second antenna can read the tag 7 and the first antenna cannot (ANT1 = OK, ANT2 = NG) (step ST302). If the management device determines that such a change has occurred (Yen in step ST302), the process proceeds to the processing step ST303, and otherwise (No in step ST302), the process proceeds to step ST304.

In step ST303, the management device 3 determines that the article 6 to which the tag 7 has been removed from the article storage 40.

As described with reference to FIG. 17, when a shopper removes an article 6 to which a tag 7 is attached from the article storage 40, the reading status with regard to respective readings of the tag 7 taken by using the first antenna 11 and the second antenna changes from a status as shown in FIG. 17A in which the first antenna can read the tag 7 and the second antenna cannot, to a status as shown in FIG. 17B in which the second antenna can read the tag 7 and the first antenna cannot. Therefore, when the reading status with regard to the reader/writer’s readings of the tag 7 has changed from a status as shown in FIG. 17A (ANT1 = OK, ANT2 = NG), to a status as shown in FIG. 17B (ANT1 = NG, ANT2 = OK), the management device 3 can determine that the article 6 to which the tag 7 has been removed from the article storage 40.

In the following step ST304, the management device 3 determines whether or not the management device 3 has received a door locking signal from the locking mechanism of the door 41. When the management device 3 determines that the management device 3 has received a door locking signal from the locking mechanism of the door 41, (Yes in step ST304, the process proceeds to step ST305, and, when determining that the management device 3 has not received a door locking signal (No in step ST304), the process returns to the previous step ST302 and the processing operations in ST302 and its subsequent steps are repeated.

In step ST305, the management device 3 turns off the reader/writer 2 (ends the operation of the reader/writer 2), and ends the reading operation for reading tags 7 of articles 6 with the use of the first antenna 11 and the second antenna 12. As a result, the article(s) 6 purchased by a shopper is finally determined. The checkout terminal 8 allows the shopper to confirm the purchase of the article 6 through the confirmation function, and then to make payment for that article 6 through the checkout function. After this processing step, the process ends.

As described above, the article management system according to the fifth embodiment of the present invention can determine that an article 6 to which a tag 7 is attached has been moved from the inside to the outside of the article storage 40, that is, determine that the article 6 has been removed from the article storage 40 based on a change in a reading status with regard to respective readings of the tag 7 taken by using the first antenna 11 and the second antenna 12, where the first and second antennas 11 and 12 are provided on the inner and outer surfaces of the door 41 of the article storage 40, respectively. The system can readily determine the change in the reading status with regard to respective readings of the tag 7 taken by using the first antennas 11 and the second antennas 12, based on the presence or absence of respective readings of the tag 7 taken by using the first antennas 11 and the second antennas 12 (refer to Step ST302). As a result, the system is enabled to reliably determine that the article has been removed from and/or placed in the article storage 40 with the use of RFID technology, without being restricted by how articles 6 are placed in the article storage 40.

Moreover, since the reader/writer 2 is activated only when the door 41 is unlocked and does not read tags 7 when the door 41 is locked, significant power saving can be achieved compared to the cases where tags of articles displayed in the article storage are collectively read by using the antennas of the reader/writer.

In the present embodiment, the first antenna 11 is provided on the inner surface of the door 41 of the article storage 40. However, the location of the first antenna 11 is not limited to this, and any location is possible as long as the first antenna 11 is located closer to the article storage 40 than the second antenna 12 in such a manner that, when an article 6 is removed from the article storage 40, a tag 7 of the article 6 can be read by using the first antenna 11, and that the reading target areas of the first and second antennas 11, 12 at least partially do not overlap with each other. For example, the first antenna 11 may be provided at a location near the door 41, or on the inner side surface, bottom surface, or upper surface of the article storage 40. Similarly, although, in the present embodiment, the second antenna 12 is provided on the outer surface of the door 41 of the article storage 40, the location of the second antenna 12 is not limited to this, and any location is possible as long as the second antenna 12 is located more remote from the article storage 40 than the first antenna 11 in such a manner that, when the article is removed from the article storage 40, a tag 7 of an article 6 can be read by using the second antenna 12, and that the reading target areas of the first and second antennas 11, 12 at least partially do not overlap with each other. For example, the second antenna 12 may be provided at a location near the article storage 40, or on the ceiling or the floor.

Moreover, although one first antenna 11 and one second antenna 12 are provided in the present embodiment, the system may include pluralities of first antennas 11 and second antennas 12. This configuration, in which the pluralities of first and second antennas are provided, can minimize the formation of null points, thereby enabling more reliable readings of tags 7 of articles 6 removed from the article storage 40.

### Variation of Fifth Embodiment

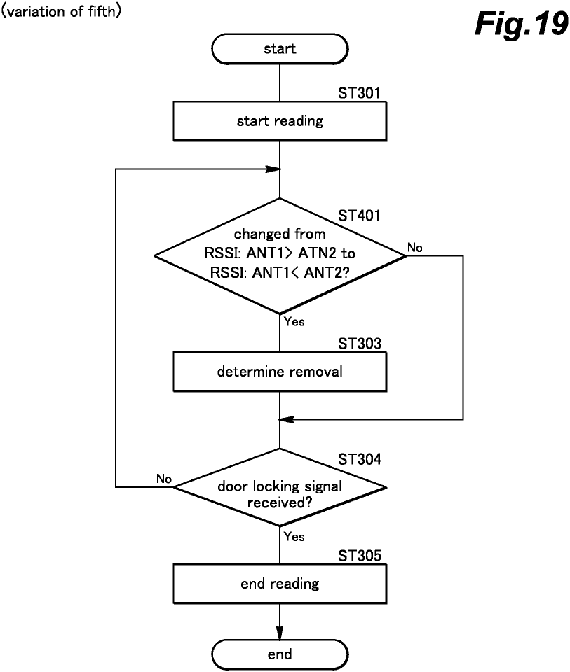

In the fifth embodiment described above, the system is configured to determine the change in the reading status with regard to respective readings of a tag 7 taken by using the first antennas 11 and the second antennas 12, based on the presence or absence of respective readings of the tag 7 taken by using the first antennas 11 and the second antennas 12. However, the reading status may be determined based on respective Receive Signal Strength Indications (RSSIs), which indicate respective reception strengths of first and second signals from the tag 7 by using the first antenna 11 and the second antenna 12, respectively. In this case, as shown in FIG. 19, step ST401 is provided in the processing operation instead of step ST302 shown in FIG. 18.

In Step ST401, the management device 3 determines whether or not the reading status with regard to Receive Signal Strength Indications (RSSIs) of first and second signals received from the tag 7 by using the first antenna 11 and the second antenna 12, respectively, has changed from a status in which the RSSI of the first signal from the first antenna 11 (ANT1) is higher than the RSSI of the second signal from the second antenna 12 (ANT2) (RSSI: ANT1> ANT2), to a status in which the RSSI of the first signal from the first antenna 11 (ANT1) is lower than the RSSI of the second signal from the second antenna 12 (ANT2) (RSSI: ANT1< ANT2). If the management device determines that such a change has occurred (Yen in step ST201), the process proceeds to the processing step ST503, and otherwise (No in step ST401), the process returns to step ST502.

In step ST503, the management device 3 determines that an article 6 to which the tag 7 is attached has been removed from the article storage 40.

As shown in FIG. 17A, when a shopper starts removal of an article 6 from the article storage 40, a tag 7 attached to the article 6 passes in front of the first antenna 11 provided on the inner surface of the opened door 41. As a result, the RSSI of the first signal from the first antenna 11 (ANT1) is higher than the RSSI of the second signal from the second antenna 12 (ANT2).

Then, as shown in FIG. 17B, when a shopper finishes removal of an article 6 from the article storage 40, a tag 7 attached to the article 6 becomes located in front of the second antenna 12 provided on the outer surface of the opened door 41. As a result, the RSSI of the first signal from the first antenna 11 (ANT1) is lower than the RSSI of the second signal from the second antenna 12 (ANT2).

Therefore, when the reading status with regard RSSIs of signals received from the tag 7 has changed from a status in which the RSSI of the first signal from the first antenna 11 (ANT1) is higher than the RSSI of the second signal from the second antenna 12 (ANT2) (RSSI: ANT1> ANT2), to a status in which the RSSI of the first signal from the first antenna 11 (ANT1) is lower than the RSSI of the second signal from the second antenna 12 (ANT2) (RSSI: ANT1< ANT2), the management device 3 can determine that an article 6 to which the tag 7 is attached has been removed from the article storage 40.

### Sixth Embodiment

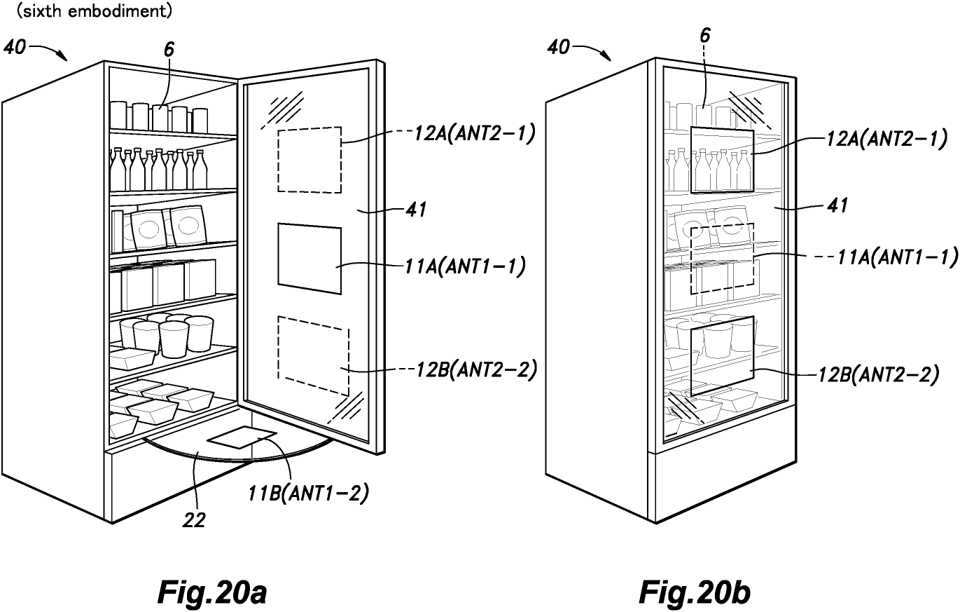

FIG. 20A and FIG. 20B illustrate a diagram showing a system of a sixth embodiment of the present invention, which corresponds to that of the fifth embodiment shown in FIG. 16. Except for what will be discussed here, this embodiment is the same as the above-described fifth embodiment and detailed descriptions related thereto will be omitted. In FIG. 20A and FIG. 20B, like reference numerals refer to like parts or elements in the fifth embodiment.

In the sixth embodiment, the article storage 40 further includes a drawer 42 configured to be housed in the article storage 40 when the door 41 is closed and to be pulled out along with the door 41 to which the drawer is connected when the door 41 is opened. The drawer 42 is formed in a fan-shaped plate shape, and one side thereof is connected to a lower portion of the door 41.

In the sixth embodiment, the system is configured to include two first antennas 11 and two second antennas 12.

The set of the first antennas 11 consists of the first antenna 11A (ANT1-1) and the first antenna 11B (ANT1-2). The first antenna 11A (ANT1-1) is provided on the inner surface of the door 41 of the article storage 40 as in the fifth embodiment, and the first antenna 11B (ANT1-2) is provided on the upper surface of the drawer 42 of the article storage 40. Thus, a tag 7 attached to an article 6 removed from the article storage 40 can be read by using the first antenna 11B (ANT1-2) provided on the upper surface of the drawer 42 from an angle which is different from that of the first antenna 11A (ANT1) provided on the inner surface of the door 41.

When being housed in the article storage 40, the first antenna 11B (ANT 1-2) provided on the drawer 42 is preferably separated from an article 6 in the article storage 40 by a shielding plate or other shielding means, so that a tag 7 attached to the article 6 in the article storage 40 cannot be read by using the first antenna 11B (ANT1-2). In this configuration, tags 7 of articles 6 can be read by using the first antenna 11B (ANT1-2) provided on the drawer 42 only when the door 41 is opened and the drawer 42 is pulled out of the article storage 40. In other words, the first antenna 11B (ANT1-2) on the drawer 42 can be used only to determine removal of an article 6 from the article storage 40.

The set of the second antennas 12 consists of the second antenna 12A (ANT2-1) and the second antenna 12B (ANT2-2). The second antenna 12A (ANT2-1) and the second antenna 12B (ANT2-2) are provided on the outer surface of the door 41 of the article storage 40 as in the fifth embodiment.. The second antenna 12A (ANT2-1) and the second antenna 12B (ANT2-2) are arranged separately from each other by a predetermined distance so that radio waves from the two second antennas do not interfere with each other.

In the sixth embodiment, a tag 7 attached to an article 6 removed from the article storage 40 can be read from different angles by using the two first antennas 11A, 11B. Thus, the configuration can minimize the formation of null points due to multipath, antennas’ orientations or other reasons, thereby improving the accuracy of readings of tags 7.

Moreover, in the sixth embodiment, since the two second antennas 12 are used, the system can more reliably read a tag 7 attached to an article 6 removed from the article storage 40 by using those two second antennas 12A and 12B. As a result the accuracy of readings of tags 7 can be further improved.

Although, in the sixth embodiment, the drawer 42 of the article storage 40 is configured to be connected to a lower portion of the door 41, the drawer 42 may be configured to be connected to an upper portion of the door 41. In this case, the first antenna 11B is provided on the lower surface of the drawer 42. Furthermore, the shape and location of the drawer 42 are not limited to those of the present embodiment, and may be any other shape and location.

Although, in the sixth embodiment, the two first antennas 11 and the two second antennas 12 are provided, the numbers of the respective first and second antennas are not limited to those of the present embodiment. For example, the system may be configured to include three first antennas and three second antennas. Alternatively, the numbers of the first and second antennas may be different.

### Seventh Embodiment

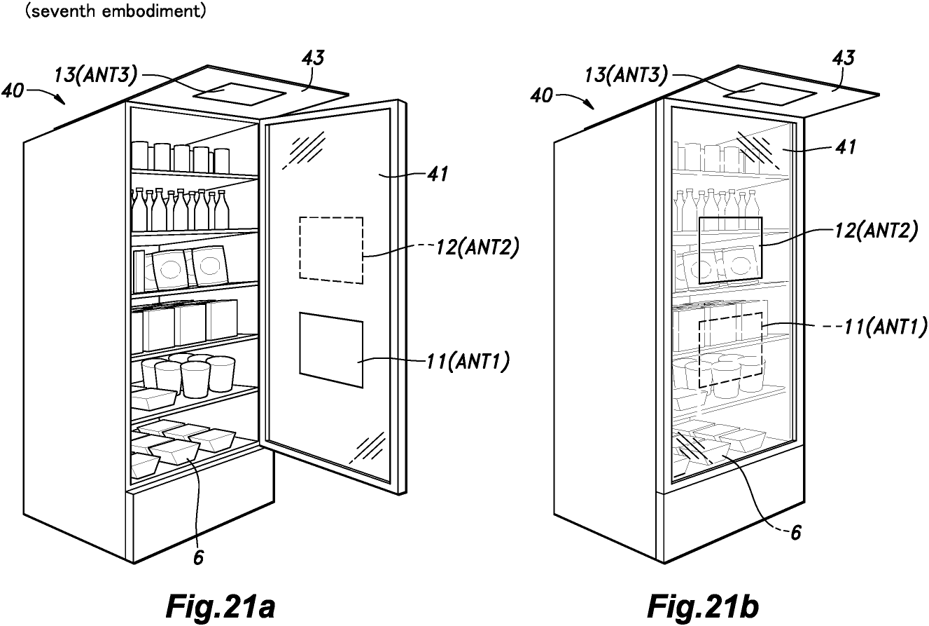

FIG. 21 is a diagram showing a system of a seventh embodiment of the present invention, which corresponds to that of the fifth embodiment shown in FIG. 16. Except for what will be discussed here, this embodiment is the same as the above-described fifth embodiment and detailed descriptions related thereto will be omitted. In FIG. 21, like reference numerals refer to like parts or elements in the fifth embodiment.

In the seventh embodiment, the article storage 40 further includes an overhang extension 43 located over the door 41. The overhang extension 43 is formed in a thin plate shape, and configured to extend out from an edge of a top surface of the housing of the article storage.

In addition, in the seventh embodiment, the reader/writer 2 includes a third antenna 13, in addition to the first antenna 11 and the second antenna 12. The third antenna 13 is arranged such that its reading target area for reading tags 7 at least partially does not overlap with those of the first and second antennas. The third antenna 13 is of the same type as the first antenna 11 and the second antenna 12, and capable of reading article information stored in each tag 7. The third antenna 13 is provided on the lower surface of the overhang extension 43. Therefore, the third antenna 13 can read tags 7 of articles 6 removed from the article storage 40, from an angle that is different from those the first antenna 11 and the second antenna 12 regardless of whether the door 41 is opened or closed.

In the seventh embodiment, when the door 41 of the article storage 40 is opened as shown in FIG. 21A, tags 7 of articles 6 removed from the article storage 40 are read by using at least one of the first antenna 11 and the third antenna 13, whereas, when the door 41 of the article storage 40 is closed as shown in FIG. 21B, tags 7 of articles 6 removed from the article storage 40 are read by using at least one of the second antenna 12 and the third antenna 13. In this way, tags 7 of articles 6 removed from the article storage 40 can be read by using the first antenna 11 and the third antenna 13 or by using the second antenna 12 and the third antenna 13, from different angles in both cases. Thus, the configuration can minimize the formation of null points due to multipath, antennas’ orientations or other reasons, thereby improving the accuracy of readings of tags 7.

In the seventh embodiment, after the door 41 of the article storage 40 is unlocked, the management device 3 can determine that an article 6 to which a tag 7 is attached has been removed from the article storage 40 only when the reading status with regard to readings of the tag 7 changes from a status in which the door 41 is opened and at least one of the first and third antennas 11, 13 can read the tag 7 and the second antenna 12 cannot read the tag 7, to a status in which the door 41 is closed and at least one of the second and third antennas 12, 13 can read the tag 7 and the first antenna 11 cannot read the tag 7.

In this way, in the seventh embodiment, the system can determine whether or not an article 6 to which a tag 7 has been removed from the article storage 40 based on the change in the reading status with regard to a reading of the tag 7 taken by using the third antenna 13, in addition to the change in the reading status with regard to respective readings of the tag 7 taken by using the first antenna 11 and the second antenna 12. More specifically, in determining movement of an article based on readings of a tag 7, the system uses the third antenna 13 in both cases; when the door 41 is opened and when the door 41 is closed, thereby enabling more reliable determination of removal of an article 6 from the article storage 40.

In the seventh embodiment, even after the door 41 is closed, tags 7 are read by the first, second, and third antennas 11, 12, and 13. Thus, in determining removal of an article 6 described with reference to FIGS. 18 and 19, when determining that the device has received a door locking signal, (Yes in step ST504), then the management device 3 performs a determination operation for determining removal of the article based on readings of the tag 7 such as those performed in step ST502 (or step ST401) and step 503.

The system may be configured to determine the changes in a reading status with regard to respective readings of a tag 7 taken by using the first, second, and third antennas 11, 12, 13 based on respective Receive Signal Strength Indications (RSSIs) of first, second, and third signals receive from the tag 7 by using the first, second, and third antennas 11, 12, 13, respectively. In this case, the management device 3 is preferably configured to determine that an article 6 to which a tag 7 is attached has been removed from the article storage 40 only when the reading status with regard to readings of the tag 7 changes from a status in which of the RSSI of at least one of the first and third signals from the first and third antennas 11, 13 is higher than that of the second signal from the second antenna 12, to a status in which the RSSI of at least one of the second and third signals from the second and third antennas 12, 13 is higher that of the first signal from the first antenna 11.

In the seventh embodiment, the third antenna 13 is provided on the overhang extension 43 of the article storage 40. However, the location of the third antenna 13 is not limited to this, and any location is possible as long as the third antenna 13 is located between the first and second antennas 11, 12 in such a manner that, when an article 6 is removed from the article storage 40, a tag 7 of the article 6 can be read by using the third antenna 13 and that the reading target area of the third antenna 13 at least partially does not overlap with those of the first and second antennas 11, 12. For example, the third antenna 13 may be provided at a location near the article storage 40, or on the ceiling or the floor. Moreover, when a system is configured to include a plurality of third antennas 13, the third antennas 13 enables more reliable readings of tags of articles removed from the article storage 40. Although, in the seventh embodiment, the overhang extension 43 is formed in a thin plate shape, the shape of the overhang extension 43 is not limited to that of the present embodiment, and may be any other shape.

### Eighth Embodiment

In an eighth embodiment, an article management system 100 is applied to the management of removal of an article from an article storage or return of an article to the article storage. In the eighth embodiment, a tag is attached to an article, and the system determines that an article has been removed from or returned to an article storage by reading the tag.

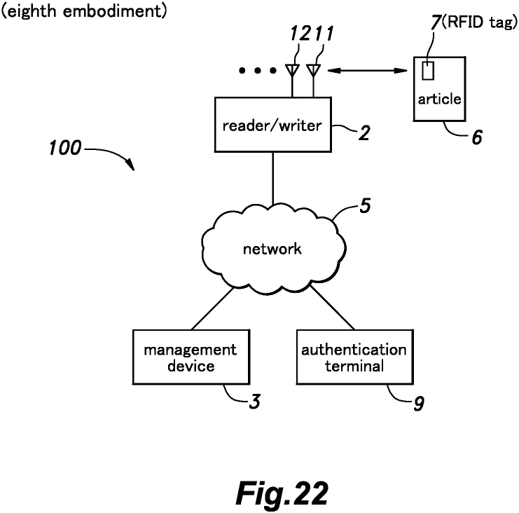

FIG. 22 is a diagram showing a general configuration of an article management system 100 of the eighth embodiment of the present invention, which corresponds to that of the fifth embodiment shown in FIG. 15. Except for what will be discussed here, this embodiment is the same as the above-described fifth embodiment and detailed descriptions related thereto will be omitted. In FIG. 22, like reference numerals refer to like parts or elements in the fifth embodiment.

As shown in FIG. 22, in the eighth embodiment, the system includes an authentication terminal 9 having a known authentication function, in place of the checkout terminal 8 (see FIG. 15) in the fifth embodiment. The authentication terminal 9 may be provided on the door 41 of the article storage 40, but the location of the authentication terminal 9 is not limited to this.

The authentication terminal 9 has an unlocking function for allowing a user to unlock the door 41 of the article storage 40 by using activation means such as an IC card or entering a password. When a user removes an article 6 from the article storage 40, a user actives the unlocking function of the authentication terminal 9, to thereby unlock the door 41 of the article storage 40 and then opens the door 41. Similarly to the fifth embodiment, when the door 41 is unlocked, a locking mechanism of the door 41 transmits an unlock signal to the management device 3, and when the door 41 is locked again, the locking mechanism transmits a door locking signal to the management device 3.

In the eighth embodiment, a tag attached to an article 6 stores article information of the article, and the first antenna 11 and the second antenna 12 of the reader/writer 2 wirelessly communicate with the tag 7, thereby reading article information on the article 6. The locking mechanism of the door 41 transmits the article information read by the reader/writer 2 to the management device 3 via the network 5.

The management device 3 manages the article information received from the reader/writer 2, and determines removal or return of the article 6 from or to the article storage 40 based on a change in the reading status regarding respective readings of article information stored in the tag 7 of the article 6 (hereinafter, simply referred to as “reading status with regard to readings of the tag 7”) taken by using the first antenna 11 and the second antenna 12. The change in the reading status with regard to readings of the tag 7 taken by using the first antenna 11 and the second antenna 12 is different between when the article 6 is removed from the article storage 40 and when the article 6 is returned to the article storage 40.

When a user removes an article 6 from the article storage 40, a reading status with regard to respective readings of the tag 7 of the article 6 taken by using the first antenna 11 and the second antenna 12, changes from a status (as shown in FIG. 17(a)) in which the first antenna 11 can read the information, but the second antenna 12 cannot, to a status (as shown in FIG. 17(b)) in which the second antenna 12 can read the information but the first antenna 11 cannot.

When a user returns an article 6 to the article storage 40, a reading status with regard to respective readings of the tag 7 of the article 6 taken by using the first antenna 11 and the second antenna 12, changes from a status (as shown in FIG. 17(b)) in which the second antenna 12 can read the information, but the first antenna 11 cannot, to a status (as shown in FIG. 17(a)) in which the first antenna 11 can read the information but the second antenna 12 cannot.

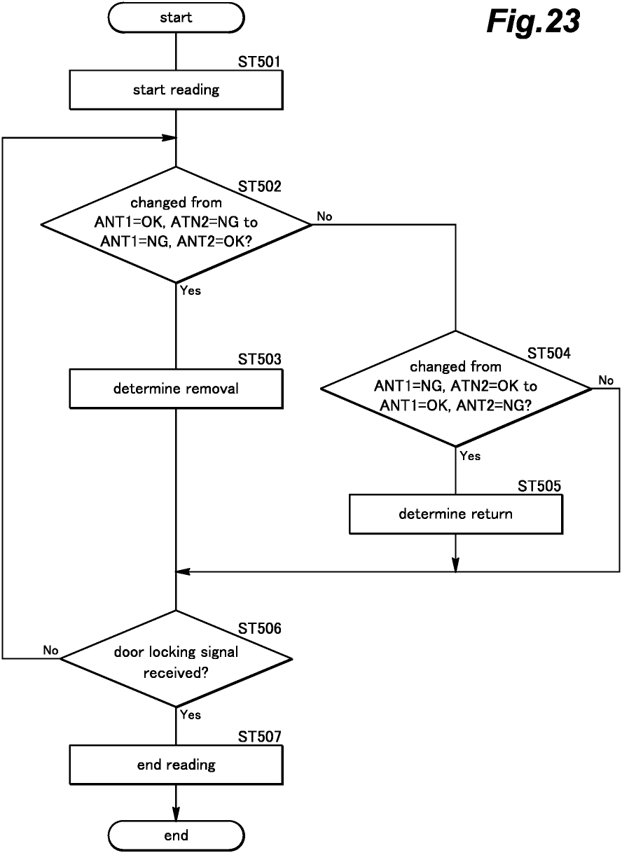

FIG. 23 is a flow chart illustrating a processing operation for determining removal or return of an article 6 from and to the article storage 40 performed by the management device 3. Referring to FIGS. 23 and 17, the processing operation for determining removal or return of an article(s) 6 will be described. First, the management device 3 starts the operation when a user actives the unlocking function of the authentication terminal 9 to thereby unlock the door 41 of the article storage 40. As described above, when the door 41 of the article storage 40 is unlocked, the locking mechanism of the door 41 transmits an unlock signal to the management device 3.

Upon receiving the unlock signal from the locking mechanism of the door 41, the management device 3 activates the reader/writer 2, and start a reading operation for reading the tag 7 of the article 6 with the use of the first antenna 11 and the second antenna 12 (step ST501).

Next, the management device 3 determines whether or not the reading status with regard to readings of the tag 7 has changed from a status in which the first antenna can read the tag 7 and the second antenna cannot (ANT1 = OK, ANT2 = NG), to a status in which the second antenna can read the tag 7 and the first antenna cannot (ANT1 = OK, ANT2 = NG) (step ST502). If the management device determines that such a change has occurred (Yen in step ST502), the process proceeds to the processing step ST503, and otherwise (No in step ST502), the process proceeds to step ST504.

In step ST503, the management device 3 determines that an article 6 to which the tag 7 is attached has been removed from the article storage 40. Then the process proceeds to step ST506.

As described above, when a user removes an article 6 to which a tag 7 is attached from the article storage 40, the reading status with regard to respective readings of the tag 7 taken by using the first antenna 11 and the second antenna, changes from a status as shown in FIG. 17A in which the first antenna can read the tag 7 and the second antenna cannot, to a status as shown in FIG. 17B in which the second antenna can read the tag 7 and the first antenna cannot. Therefore, when the reading status with regard to respective readings of the tag 7 has changed from a status as shown in FIG. 17A (ANT1 = OK, ANT2 = NG), to a status as shown in FIG. 17B (ANT1 = NG, ANT2 = OK), the management device 3 can determine that the article 6 to which the tag 7 has been removed from the article storage 40.

In step ST504, the management device 3 determines whether or not the reading status of the tag 7 has changed from a status as shown in FIG. 17A (ANT1 = OK, ANT2 = NG), to a status as shown in FIG. 17B (ANT1 = NG, ANT2 = OK). When the management device 3 determines the change of the status of the tag has occurred (Yes in ST504), the process proceeds to step ST505, and otherwise (No in ST504), the process proceeds to step ST506.

In step ST505, the management device 3 determines that an article 6 to which the tag 7 has been returned to the article storage 40, and then the process proceeds to step ST506.

As described above, when a user returns an article 6 to which a tag 7 is attached to the article storage 40, the reading status with regard to respective readings of the tag 7 taken by using the first antenna 11 and the second antenna, changes from a status as shown in FIG. 17B in which the second antenna can read the tag 7 and the first antenna cannot, to a status as shown in FIG. 17A in which the first antenna can read the tag 7 and the second antenna cannot. Therefore, when the reading status with regard to respective readings of the tag 7 taken by using the first and second antennas, has changed from status as shown in FIG. 17B (ANT1 = NG, ANT2 = OK), to a status as shown in FIG. 17A (ANT1 = OK, ANT2 = NG), the management device 3 can determine that the article 6 to which the tag 7 has been returned to the article storage 40.

In the following step ST506, the management device 3 determines whether or not the management device 3 has received a door locking signal from the locking mechanism of the door 41. When the management device 3 determines that the management device 3 has received a door locking signal from the locking mechanism of the door 41, (Yes in step ST506, the process proceeds to step ST507. When determining that the management device 3 has not received a door locking signal (No in step ST506), the process returns to the previous step ST502 and the processing operations in ST502 and its subsequent steps are repeated.

In step ST507, the management device 3 turns off the reader/writer 2 (ends the operation of the reader/writer 2), and ends the reading operation for reading tags 7 of articles 6 with the use of the first antenna 11 and the second antenna 12. After this processing step, the process ends.

As described above, the article management system according to the eighth embodiment of the present invention can determine removal or return of an article 6 to which a tag 7 is attached from and to the article storage 40 based on a change in the reading status with regard to respective readings of the tag 7 taken by using the first antenna 11 and the second antenna 12. As a result, the system can reliably determine that the article has been removed from or returned to the article storage 40 with the use of RFID technology, without being restricted by how articles 6 are placed in the article storage 40.

The change in the reading status with regard to respective readings of the tag 7 taken by using the first antennas 11 and the second antennas 12 can be readily determined based on the presence or absence of the respective readings of the tag 7 taken by using the first antennas 11 and the second antennas 12. In addition, similarly to the variation of the fifth embodiment, the change in the reading status may be determined based on respective Receive Signal Strength Indications (RSSIs), which indicate respective reception strengths of first and second signals from the tag 7 by using the first antenna 11 and the second antenna 12, respectively.

Moreover, since the reader/writer 2 is activated only when the door 41 is unlocked and does not read tags 7 when the door 41 is locked, significant power saving can be achieved compared to the cases where tags of articles displayed in the article storage are collectively read by using the antennas of the reader/writer.

In the present embodiment, the first antenna 11 and the second antenna 12 are provided on the inner surface and the outer surface of the door 41 of the article storage 40, respectively. However, the locations of the first antenna 11 and the second antenna 12 are not limited to these, and any locations are possible as long as the first and second antennas 11, 12 are located in such a manner that, when an article 6 is removed from the article storage 40, a tag 7 of the article 6 can be read by using the first and second antennas 11, 12, and that the reading target areas of the first and second antennas 11, 12 at least partially do not overlap with each other. For example, the first antenna 11 may be provided at a location near the door 41 and the second antenna 12 may be provided at a location near the article storage 40 or on the ceiling or the floor.

Furthermore, in a similar manner to the sixth embodiment, pluralities of first antennas 11 and second antennas 12 may be provided, and/or similarly to the seventh embodiment, a third antenna may be additionally provided, thereby improving the accuracy of readings of tags 7.

When a third antenna 13 is provided, the system is preferably configured to determine that an article 6 to which a tag 7 is attached has been removed from the article storage 40 in the same manner as the seventh embodiment. In the case where a system is configured to determine that an article 6 to which a tag 7 is attached has been returned to the article storage 40 based on the presence or absence of the respective readings of the tag 7 taken by using the first, second, and third antennas 11, 12, and 13, the management device 3 can determine that an article 6 to which a tag 7 is attached has been removed from the article storage 40 when the reading status with regard to readings of the tag 7 changes from a status in which at least one of the first and third antennas 11, 13 can read the tag 7 and the second antenna 12 cannot, to a status in which at least one of the second and third antennas 12, 13 can read the tag 7 and the first antenna 11 cannot. In the case where a system is configured to determine that an article 6 to which a tag 7 is attached has been returned to the article storage 40 based on respective Receive Signal Strength Indications (RSSIs), which indicate respective reception strengths of first, second, and third signals from the tag 7 by using the first, second, and third antennas 11, 12, 13, respectively, the management device 3 can determine that the article 6 to which the tag 7 is attached has been removed from the article storage 40 only when the reading status has changed from a status in which the RSSI of at least one of the second and third signals from the second and third antennas 12, 13 is higher than that of the first signal from the first antenna 11, to a status in which the RSSI of at least one of the first and third signals from the first and third antennas 11, 13 is higher than that of the second signal from the second antenna 12.

While specific embodiments of the present invention are described herein for illustrative purposes, the present invention is not limited to the specific embodiments. In the article management devices and the article management methods of the above-described embodiments, not all elements therein are essential. Thus, various modifications including omissions of some elements may be made for the elements of the embodiments as appropriate without departing from the scope of the invention.

For example, an article management device and an article management method according to the present invention may be applied to an inventory management system for articles (items) displayed on an article storage. Such configuration can manage actual inventory figures through the determination of removal or return of articles from and to an article storage, thereby prospectively preventing excess inventory and inventory shortages.

### INDUSTRIAL APPLICABILITY

An article management device and an article management method according to the present invention are useful as an article management device and an article management method for enabling reliable determination of movement of an article with an attached RFID tag.

GLOSSARY

| | |
|---|---|
| 1 | article management system (checkout system) |
| 2 | reader/writer |
| 3 | management device |
| 4 | POS terminal |
| 5 | network |
| 6 | article (item) |
| 7 | RFID tag (tag) |
| 8 | checkout terminal |
| 9 | authentication terminal |
| 10 | checkout counter |
| 11 | first antenna |
| 12 | second antenna |
| 13 | third antenna |
| 14 | shielding plate |
| 21 | pre-payment basket |
| 22 | post-payment basket |
| 40 | article storage |
| 41 | door |
| 42 | drawer |
| 43 | overhang extension |
| 100 | article management system |

What is claimed is:

1. An article management system for determining movement of an article to which an RFID tag is attached, the article management system comprising:
one or more first antennas provided on a side of a first prescribed region and one or more second antennas provided on a side of a second prescribed region such that the first antennas and the second antennas have respective reading target areas which at least partially do not overlap with each other;
a reader/writer configured to read article information stored in the RFID tag attached to the article by using the first antennas and the second antennas, respectively; and
a management device configured to manage the article information read by the reader/writer from the RFID tag,
wherein, for each RFID tag from which the reader/writer has read article information stored therein, the management device determines that a corresponding article to which the RFID tag is attached has been moved between the first prescribed region and the second prescribed region based on a change in a reading status with regard to respective readings of the RFID tag taken by using the first antennas and the second antennas.

2. The article management system according to claim 1, wherein the article is an article to be stored in an article storage,
wherein the first prescribed region is a region within the article storage,
wherein the second prescribed region is a region outside the article storage, and
wherein, for each tag read by the reader/writer, the management device determines that the article to which the RFID tag is attached has been removed from and/or placed in the article storage based on the change in the reading status with regard to the reader/writer’s readings of the first and second signals.

3. The article management system according to claim 2, wherein the management device measures reception signal intensities of first and second signals received from each RFID tag by using the first antennas and the second antennas, respectively, and
wherein the management device determines that the article to which the RFID tag is attached has been removed from the article storage when the reading status changes from a status in which the reception signal intensity of the first signal is higher than that of the second signal, to a status in which the reception signal intensity of the first signal is lower than that of the second signal, and
determines that the article to which the RFID tag is attached has been placed in the article storage when the reading status changes from a status in which the reception signal intensity of the second signal is higher than that of the first signal, to a status in which the reception signal intensity of the second signal is lower than that of the first signal.

4. The article management system according to claim 2, wherein the article storage includes a hinged door to be used when the article is removed from or placed in the article storage,
wherein the first antennas are provided on an inner surface of the door, and
wherein the second antennas are provided on an outer surface of the door.

5. The article management system according to claim 4, wherein the article storage further comprises a drawer configured to be housed in the article storage when the door is closed and to be pulled out along with the door to which the drawer is connected when the door is opened, and
wherein at least one of the first antennas is provided on the drawer.

6. The article management system according to claim 4, wherein at least parts of the door where the first and second antennas are disposed are formed of an electromagnetic shielding material or a radio wave absorbing material.

7. The article management system according to claim 4, wherein at least parts of the door where the first and second antennas are disposed are made transparent, and
wherein the first and second antennas are formed of transparent electrically conductive material.

8. The article management system according to claim 2, wherein the reader/writer further comprises one or more third antennas between the first and second antennas such that the third antennas’ reading target area at least partially does not overlap with those of the first and second antennas, and that the reader/writer further reads article information stored in the RFID tag attached to the article by using the third antennas,
wherein, for each RFID tag from which the reader/writer has read article information stored therein, the management device determines that the article to which the RFID tag is attached has been removed from or placed in the article storage based on the change in a reading status with regard to a reading of the RFID tag taken by using the third antennas, in addition to the change in the reading status with regard to respective readings of the RFID tag taken by using the first and second antennas.

9. The article management system according to claim 8, wherein the management device measures reception signal intensities of first and second signals received from each RFID tag by using the first antennas and the second antennas, respectively, and determines that the article to which the RFID tag is attached has been removed from the article storage when the reading status changes from a status in which the reception signal intensity of at least one of the first and third signals is higher than that of the second signal, to a status in which the reception signal intensity of at least one of the second and third signals is lower than that of the first signal, and determines that the article to which the RFID tag is attached has been placed in the article storage when the reading status changes from a status in which the reception signal intensity of at least one of the second and third signals is higher than that of the first signal, to a status in which the reception signal intensity of at least one of the first and third signals is lower than that of the second signal.

10. The article management system according to claim 8, wherein the article storage includes: a hinged door to be used when the article is removed from or placed in the article storage; and an overhang extension located over the door, and
wherein the third antennas are disposed on a lower surface of the overhang extension.
